(19) United States
(12) Patent Application Publication
(10) Pub. No.: US 2015/0370848 A1
(43) Pub. Date: Dec. 24, 2015

(54) SYSTEM AND METHOD FOR MANAGING DATA INTEGRITY IN ELECTRONIC DATA STORAGE

(71) Applicant: AUVIK NETWORKS INC., Waterloo (CA)

(72) Inventors: David YACH, Waterloo (CA); Marc MORIN, Waterloo (CA); Alexander HOFF, Waterloo (CA)

(21) Appl. No.: 14/747,006

(22) Filed: Jun. 23, 2015

Related U.S. Application Data
(60) Provisional application No. 62/015,804, filed on Jun. 23, 2014.
(60) Provisional application No. 62/016,140, filed on Jun. 24, 2014.

(51) Int. Cl. G06F 17/30; G06F 11/30

(52) U.S. Cl. CPC G06F 17/30371; G06F 11/3065; G06F 17/3051

(57) ABSTRACT

A method for managing data integrity including: receiving a plurality of constraints related to a data structure stored in a data storage component; analyzing each of the plurality of constraints to determine a plurality of conditions based on the plurality of constraints; determining, a plurality of operations based on each of the plurality of conditions, wherein each operation provides for changes in data; and generating code based on the at least one constraint, the conditions and the operations. A system for managing data integrity including: a transmitter module configured to receive a plurality of constraints; a constraint translator module configured to analyze each of the plurality of constraints to determine a plurality of conditions based on the plurality of constraints; an analysis component configured to determine a plurality of operations based on each of the plurality of conditions, wherein each operation provides for changes in data; and wherein the constraint translator module is further configured to generate code.

### RELATED APPLICATIONS

This application claims priority to U.S. Provisional Patent Application No. 62/015,804 filed Jun. 23, 2014, and U.S. Provisional Patent Application No. 62/016,140 filed Jun. 24, 2014.

### FIELD

The present disclosure relates generally to managing data integrity. More particularly, the present disclosure relates to a system and method for managing, enforcing and maintaining data integrity of data stored within an electronic data storage system.

### BACKGROUND

Databases and data stores are used to store and evaluate data in many industries. The validity of the stored data is often integral to the products or services being managed by the databases. Industries are often required to evaluate the data to ensure data integrity, for example, maintaining and assuring the completeness, accuracy and consistency of the stored data over the life-cycle of the stored data. An example industry where large amounts of data are stored and processed in the computer network industry.

In some cases, database analysts or systems analysts may need to review the data periodically to ensure that data integrity is maintained. In other cases, analysts may develop various conditions or programs intended to review the data to determine whether data integrity has been maintained. Conventionally, determining data integrity has required human input, which is time consuming and expensive and can result in human errors being created in the data, or errors not being discovered during a review of the data.

As such, there is a need for an improved system and method for maintaining data integrity.

### SUMMARY

In one aspect, there is provided a method for managing data integrity including: receiving, at a transmitter module, a plurality of constraints related to a data structure stored in a data storage component; analyzing, at a constraint translator module, each of the plurality of constraints to determine a plurality of conditions based on the plurality of constraints; determining, at an analysis component, a plurality of operations based on each of the plurality of conditions, wherein each operation provides for changes in data associated with a portion of the data structure; and generating, at the constraint translator module, computer executable code based on the at least one constraint, the conditions and the operations.

In a particular case, the data structure may be a plurality of tables and a portion of the data structure is a table within the plurality of tables.

In another particular case, the method may include, executing, at a processor, the generated code to determine changes required to data previously stored in the data structure.

In still another particular case, the method may include, notifying a constraint author of a condition that cannot be resolved.

In yet another particular case, determining the plurality of operations may include determining downstream operations based on the determined operations, wherein the downstream operations provide for changes in data associated with other portions of the data structure.

In still yet another particular case, determining operations may be based on predetermined preferences.

In a particular case, analyzing each of the plurality of constraints may include determining corner cases related to the constraint.

In another particular case, the method may include: monitoring, at a monitoring component, for a change made to a portion of the data structure; determining, at a constraint executor module, whether the change violates a constraint of the plurality of constraints; and if the change violates the constraint, returning each portion of the data structure to a valid state, otherwise proceeding with the change, at a modification component.

In still another particular case, returning each portion of the data structure to a valid state may include executing, at a processor, the generated code to determine changes required to data previously stored in the data structure.

In yet another particular case, returning each portion of the data structure to a valid state may include: determining downstream operations based on the change to the portion of the data structure, wherein the downstream operations provide for changes in data associated with other portions of the data structure.

In another aspect, there is provided a system for managing data integrity including: a transmitter module configured to receive a plurality of constraints related to a data structure stored in a data storage component; a constraint translator module configured to analyze each of the plurality of constraints to determine a plurality of conditions based on the plurality of constraints; an analysis component configured to determine a plurality of operations based on each of the plurality of conditions, wherein each operation provides for changes in data associated with a portion of the data structure; and wherein the constraint translator module is further configured to generate computer executable code based on the at least one constraint, the conditions and the operations.

In a particular case, the data structure may be a plurality of tables and a portion of the data structure is a table within the plurality of tables.

In another particular case, the system includes a processor configured to execute the generated code to determine changes required to data previously stored in the data structure.

In still another particular case, the system may include a transmitter module configured to notify a constraint author of a condition that cannot be resolved.

In yet another particular case, the analysis component may be configured to determine downstream operations based on the determined operations, wherein the downstream operation provide for changes in data associated with other portions of the data structure.

In still yet another particular case, determining operations may be based on predetermined preferences.

In a particular case, the analysis component may be configured to determine corner cases based on the plurality of constraints.

In another particular case, the system may further include: a monitoring component configured to monitor for a change made to a portion of the data structure; a constraint executor module configured to determine whether the change violates a constraint of the plurality of constraints; and a modification component configured to, if the change violates the constraint, return each portion of the data structure to a valid state, otherwise proceeding with the change.

In still another particular case, the system may include a processor configured to return each portion of the data structure to a valid state by executing the generated code to determine changes required to data previously stored in the data structure.

In yet another aspect, there is provided a method for managing data integrity including: monitoring for a change made to a portion of a data structure stored in a data storage component; analyzing updates to each portion of the data structure based on the change; and determining whether the change violates at least one predetermined constraint associated with a portion of the table structure, wherein if the change violates at least one predetermined constraint, returning the data structure to a valid state by performing data changes to other portions of the data structure, otherwise proceeding with the change.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 illustrates a system for managing data integrity, according to an embodiment;

FIG. 2 is an example flow chart illustrating a method for managing data integrity, according to an embodiment;

FIGS. 3A to 3D illustrate a graph of constraints according to an example;

FIGS. 4A to 4C illustrate a graph of constraints according to another example;

FIG. 5 is an example flow chart illustrating a method for managing data integrity for data changes;

FIGS. 6A to 9 illustrate aspects of a system and method for network topology, according to an embodiment.

### DETAILED DESCRIPTION

Generally there is provided a method and system for managing data integrity. For example, managing, enforcing and maintaining data integrity of data stored within a data storage system such as a database. An electronic data storage system will generally have explicit and/or implicit rules defining valid states of the data, referred to as constraints. Applications which manipulate that data are generally designed to ensure the state of the data remains valid; put another way, the data satisfies the constraints. Traditional programming practice puts the onus on a programmer and/or tester to ensure that any given change to the data preserves the validity rules, however, this may lead to cascading defects whenever a single program leaves the data in a bad state. The system and method provided herein are intended to assist with managing data integrity, and in particular, take a validity definition (for example, a constraint on the data) and automatically generate computer executable code that will react to any change to the data and take appropriate follow-up actions to keep the data in a valid state or put the data in a new valid state. Further, the generated code can be executed to monitor for external changes to the data that may put the data in an invalid state and the generated code is intended to make subsequent data changes to put the data back in a valid state or in a new valid state.

To illustrate the method and system described herein, a simplified example is provided using sample tables for a school consisting of tables representing students (referred to as “Students” or “student table”), courses (referred to as “Courses” or “courses table”, and course registrations (referred to as “Register” or “register table”).

| Student Id | Name | Gender |
|---|---|---|
| 101 | Alice | F |
| 102 | Bob | M |
| Course Id | Name | Credits |
| 201 | Math | 1.0 |
| 202 | Physics | 0.5 |
| Register Id | Student Id | Course Id |
| 301 | 101 | 201 |
| 302 | 101 | 202 |
| 303 | 102 | 202 |

The sample data uses a common technique of using numeric values to uniquely identify rows but the techniques herein are not intended to rely on this. In this sample data, there are two students Alice and Bob, and two courses for Math and Physics. As shown in the register table, Alice is registered for both courses (numbered 201 and 202) while Bob is only registered for Physics (numbered 202). The common term used to describe such a related set of tables is schema; this sample can be called the School Schema. This schema has been simplified for illustrative purposes. It will be understood that the schema for a real school would be much more complicated (for example, storing both first names and last names and a much larger number of students, courses, and registrations). Although the example here is shown as a collection of tables, the data may be represented in various data structures which provide for relationships between various stored data and may require the data to maintain integrity throughout the lifetime of the data.

One skilled in the art would infer some constraints on this data such as:
1. All Student Id's should be unique i.e. no two rows in the Student table should have the same Student Id. This may be called a primary key because of the nature if the constraint.
2. Similarly, Course Id is a primary key for the Course table, and Register Id is a primary key for the Register table.
3. In the Register table, each Student Id and Course Id must correspond to an existing primary key in the respective Student and Course tables. This is called a foreign key because it relates to another table.
4. The gender column can only contain the values M and F. This is called a value constraint.

Generally, any database must comply with these constraints with regard to the primary key, foreign key and value constraints in order to maintain valid data. Thus, in making a change to the database (i.e. one of these tables), the change must either not violate any constraint or additional follow-on changes must be made that, taken together, put the data back in a valid state.

For example, suppose the student named Bob is deleted from the Student table. Then the foreign key constraint in Register will be invalid since there is a value 102 in the Student Id column yet no longer a corresponding row in the Student Id table.

| Student Id | Name | Gender |
|---|---|---|
| 101 | Alice | F |

One way to ensure the data is valid is to refuse to allow the deletion of the row for Bob. Another way to make the data valid would be to cause the corresponding row in Register to also be deleted. The deletion of the corresponding row in Register, together with the deletion of Bob, puts the data back in a valid state.

Conventional systems typically allow the programmer to select one of these two behaviors for each foreign key in the system. For example, in SQL™ the default behavior is to deny the change, which can be overridden to say CASCADE DELETE to provide the second behavior. Thus, with a single simple declaration, any program working with the tables in the School Schema will automatically provide the prescribed behavior. This is intended to make the programs easier to create and provide consistent behavior across all programs.

Further, SQL also provides a third option, CASCADE NULL, which would replace the 102 in the Register table with a special value called NULL representing “not a valid value” in this case.

The method and system for managing data integrity described herein is intended to improve on conventional systems which merely cascade a constraint among tables.

For example, conventional systems may have difficulty dealing with more complex constraints. In the example above, consider a new constraint that “all female students must be registered in Math”. This can be described as a constraint involving all three tables:

if (Student.Gender==“F”) assert(exists(Student.StudentId==Register.StudentId && Register.CourseId=Course.CourseId && Course.Name==“Math”))

Here the use of == represents a test for equality, && is used to mean AND, and assert( ) specifies a constraint that must be true.

In a conventional system, this requirement or constraint would generally need to be handled by an application programmer who could translate the requirement into various cases in order for the data integrity to be maintained:
1. If a new student is inserted, and that student is female, the constraint is invalid. The logical solution would be to add a registration for that student in the Math course.
2. If a student is deleted, there is no effect on the constraint so that is allowed.
3. If registration is deleted, and if that registration is for a female student and the corresponding course is Math, there is a constraint violation.
4. If a course is deleted, and that is the Math course, then the constraint is violated.

While this case list might appear reasonable to most programmers, it turns out to be incomplete and incorrect. For example, it is missing the following cases:
1. If the Math course is deleted, the constraints are okay if there are no female students.
2. Item 4 above is one case of a general problem that happens if there is no Math course in the table.
3. If a registration row is modified, what happens?
4. If a student changes gender from M to F (for example, if there was a data entry error or the like) then she must be registered in Math

These extra conditions are generally known as Corner Cases, a term referring to conditions that aren't normal occurrences but that can happen.

The method and system described herein are intended to automatically manage data integrity for complex constraints, including the determining and managing of Corner Cases.

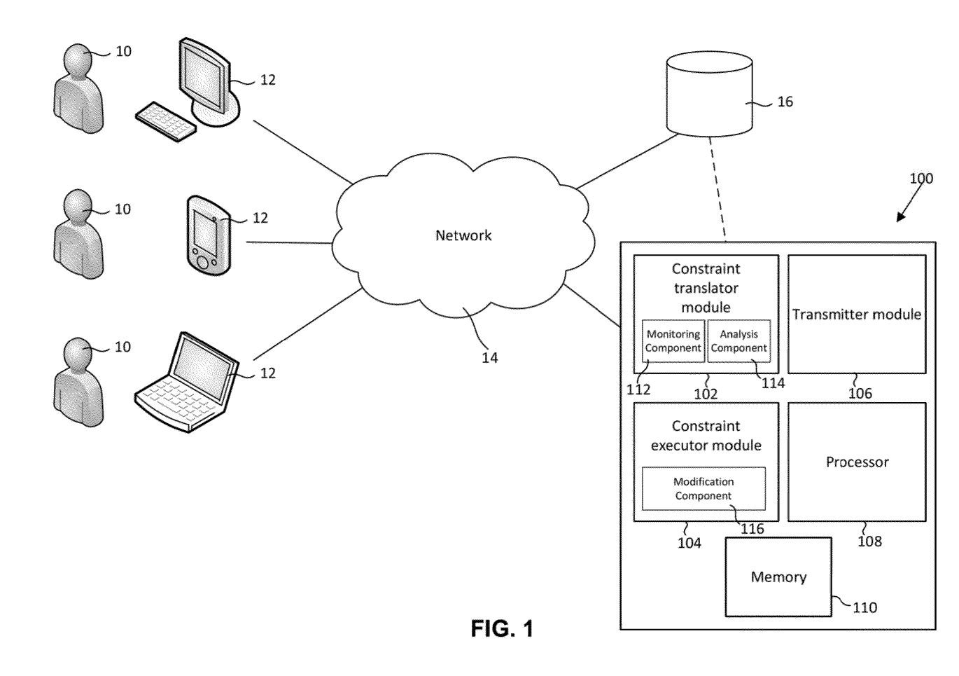

FIG. 1 illustrates a system 100 for managing data integrity. The system 100 includes a Constraint Translator module 102, a Constraint Executor module 104, a transmitter module 106, a processor 108 and a memory module 110. In some cases, the system 100 may be connected to at least one user 10, for example a constraint author, via user equipment 12 attached to a network 14, for example, the Internet, a Local Area Network (LAN), a Virtual Local Area Network (VLAN), a Wide Area Network (WAN), a Virtual Private Network (VPN), or the like. In other cases, the system may be on a local computer and accessed directly.

The system 100 may also be operatively connected to at least one database or data storage component 16, which may be external or local. The system 100 may query the data storage component 16 and may retrieve electronic content from the data storage component 16. The data storage component 16 includes one or more tables. Each table may include at least one column and zero or more rows of data. It is intended that each table would support table operations, for example, insertion of a new row; deletion of an existing row; updating the value in one or more of the columns; updating the value in one or more rows, or the like. It should be noted that the reference to “table” herein is related to a representation of data and not necessarily the actual data structure within the physical memory.

The processor 108 is generally configured to execute instructions from the other modules and components of the system 100. In some cases, the processor 108 may be a central processing unit. In other cases, each module may be operatively connected to a separate processor. The system 100 further includes a memory module 110, for example a database, random access memory, read only memory, or the like.

The transmitter module 106 is configured to receive and transmit data to and from the network 14, the at least one database 16, or the like. The transmitter module 106 may be, for example, a communication module configured to communicate between another device and/or the network 14.

It will be understood that in some cases, the system 100 may be a distributed system wherein the modules and/or components may be operatively connected but may be hosted over a plurality of network devices.

The Constraint Translator module 102 is configured to receive a constraint, for example from a user 10, and translate the constraint to a program that considers all possible changes and in each case makes additional follow-on cascading changes as necessary to satisfy the constraint. Further, the Constraint Translator module 102 is configured such that these changes make sense (i.e. maintain data integrity) for the given data set. For example, all the constraints mentioned thus far are satisfied if every row in all three tables is deleted, but clearly there will be situations where that is not a desirable outcome.

The Constraint Translator module 102 may include a monitoring component 112 and an analysis component 114. The monitoring component 112 is configured to monitor for changes in the data or receive notifications with respect to changes in the data. The analysis component 114 is configured to identify the modifications to the data which may violate at least one constraint and generate instructions or code, which may be executed by the Constraint Executor module 104 or by another component of the system 100.

The analysis component 114 is configured to identify constraints and determine sufficient constraints such that any modification to the data would result in the appropriate changes to the related data such that no constraints are violated and the data remains in a valid state or is returned to a valid state.

For example, the analysis component 114 identifies specific data modifications for which no permitted table operations can be performed and is intended to remove these violations from the constraints provided to the system 100. The analysis component 114 is further intended to identify downstream or follow-on data modifications and related computations that may be necessary to ensure that constraints are satisfied.

The Constraint Executor module 104 is configured to run the program created by the Constraint Translator module 102. The Constraint Executor module 104 includes a modification component 116. The modification component 116 is configured to modify the data.

The Constraint Executor module 104 may have two modes of operation, a passive mode and a reactive mode. In the passive mode, a request is made to the Constraint Executor module 104 to check all the constraints and to make any further changes necessary to put the data back in a valid state by, for example, inserting rows, deleting rows, updating column values, or the like. This request may be made through various methods, such as a procedure call, HTTP request, or other software request mechanism. In the reactive mode, the Constraint Executor module 104 runs continuously or periodically and monitors for changes to the data. For each change in the data, the Constraint Executor module 104 checks constraints and makes further changes to put the data in a valid state.

The reactive mode is generally equivalent to monitoring for any change, and after each change, making a request to the passive mode. However, for some types of data this may be inefficient because most changes to a single row in a single table will only affect a small subset of the full set of constraints, if any. Consequently, the Constraint Translator module 102 can be configured to analyze each type of change (for example, an insert, an update, or a delete for each table) and generate separate code for each type of change.

As with the foreign key example above, a constraint author, for example, a system administrator, a system user, a programmer, or the like, may provide some guidance as to the allowed changes. In the case of the constraint that all female students must be registered in Math, the guidance may be that all changes should only impact the registration table by adding new rows. A simple way to indicate this in the constraint above is to annotate the register table as the “special” one, here illustrated using an apostrophe.

if (Student.Gender == “F”) assert(exists(Student.StudentId==
Register’.StudentId &&
Register’.CourseId==Course.CourseId && Course.Name==”Math”))

This annotation is borrowed from mathematics, where it would be read as “Register prime” meaning “the new contents of the Register table”. Here is a second example using the prime notation, in this case indicating that the Credits column can be modified (as opposed to the first example which allowed modification of a table, as opposed to merely a column in the table):

if (Course. Name==“Physics”) Assert(Course.Credits′>=1.0)

In looking at the constraint on female students above, the Constraint Translator module 102 would report that this is an invalid constraint because there is a corner case that is not handled i.e. when there is no Math course and there is at least one female student. This means the original constraint was poorly specified; a more precise constraint is “if there is a Math course, then all female students must take that course”.

if (Student.Gender == “F” && Course.Name==”Math”)
assert(exists(Student.StudentId==Register’.StudentId &&
Register’.CourseId==Course.CourseId))

Given this more precise constraint, the Constraint Translator module 102 would then produce the following actions to handle the constraint and make data modifications. The details of how the Constraint Translator module 102 would identify that the first constraint is missing a corner case (which is when there is no Course called “math”), and how it would decide to resolve the more-precise second constraint by registering any new female students in the math course, are described later herein.

```
on delete (r<-Register)
    for (c<-Course where “Math”==c.Name&&c.CourseId==r.CourseId)
        for (s<-Student where “F”==s.Gender&&r.StudentId==s.
        StudentId)
            Register(CourseId=c.CourseId, StudentId=s.StudentId);
on insert (c<-Course)
    if (“Math”==c.Name)
        for (s<-Student where “F”==s.Gender)
            for (r<-Register where
        c.CourseId==r.CourseId&&r.StudentId==s.StudentId)
                found(r);
            otherwise
                  Register(CourseId=c.CourseId, StudentId=s.
                  StudentId);
on insert (s<-Student)
    if (“F”==s.Gender)
        for (c<-Course where “Math”==c.Name)
            for (r<-Register where
        c.CourseId==r.CourseId&&r.StudentId==s.StudentId)
                found(r);
            otherwise
                Register(CourseId=c.CourseId, StudentId=s.
                StudentId);
on update (c,_c<-Course)
    if (“Math”==c.Name&&“Math”!=_c.Name)
        for (s<-Student where “F”==s.Gender)
            for (r<-Register where
        c.CourseId==r.CourseId&&r.StudentId==s.StudentId)
                found(r);
            otherwise
                Register(CourseId=c.CourseId, StudentId=s.
                StudentId);
on update (r,_r<-Register) {
    if(_r.CourseId!=r.CourseId||_r.StudentId!=r.StudentId)
        for (c<-Course where “Math”==c.Name&&_r.
        CourseId==c.CourseId)
            for (s<-Student where
(“F”==s.Gender&&_r.StudentId==s.StudentId&&c.CourseId!=r.
CourseId) ||
(“F”==s.gender&&_r.StudentId==s.StudentId&&r.StudentId!=s.
StudentId))
            Register(CourseId=c.CourseId, StudentId=s.StudentId);
}
on update (s,_s<-Student)
    if (“F”==s.Gender&&“F”!=_s.Gender)
        for (c<-Course where “Math”==c.Name)
            for (r<-Register where
        c.CourseId==r.CourseId&&r.StudentId==s.StudentId)
                found(r);
            otherwise
                Register(CourseId=c.CourseId, StudentId=s.
                StudentId);
```

The system and method detailed herein can be considered as providing event-based programs that react to changes in the database. The on delete(r<-Register) statement executes the statements indented below it for each registration row deleted from the data, and refers to that row with the short form r within those statements. The for (c<-Course where “Math”==c.name && c.CourseId==r.CourseId) finds all courses which are both named Math and have the corresponding CourseId, and for each such row executes the indented statement referring to that one course as c. The if statement has the common meaning used in most computing languages. The otherwise statement is associated with a for statement and is executed unless the corresponding found(x) is reached. The Register(CourseId=c.CourseId, StudentId=s.StudentId) creates and inserts a new row in the Register table. Finally, the update event on update (c, _c<-Course) is similar to delete but also provides both the row after update as c and the row before update as _c.

Note that this solution addresses the corner cases mentioned earlier, including the complicated case where the Register table changes. The initial constraint with regard to females being required to take math is translated into many lines of code to properly handle all cases, including corner cases, which may be easily overlooked by programmers, testers and the like.

For each additional constraint entered into the system 100, by the constraint author, the system 100 will typically create a similar or larger body of code which is intended to handle all corner cases for that constraint. As more tables are added to a single constraint, more corner cases may generally be considered. Further, multiple constraints may interact with each other, making it more complicated to change the data back to a valid state and more complex to find corner cases. Taken together, even a reasonable number of constraints may result in a large number of corner cases to handle all constraints concurrently. The system and method detailed herein are intended to exhaustively analyze each constraint and are intended to determine and resolve all corner cases in order to maintain data integrity. Any time the constraint author introduces new tables, new constraints, modifies existing constraints, or the like, the Constraint Translator module 102 is run anew, to generate code for a new set of actions to be carried out.

One skilled in the art will realize that the code could be generated in any appropriate programming language, including C, C++, Java, Scala, Perl, Python and many others; the examples here are illustrative only.

By automating the creation of code to handle the corner cases and ensuring that corner cases are not missed, the system and method are intended to avoid defects that are often introduced when creating applications that manipulate data.

Further, the system and method are intended to allow a user, for example, a programmer, a constraint author, or the like, to automatically create a smaller program, which is intended to result in fewer programming errors. In the example given, a program to add new students only needs to insert a row into the Student table; the code generated by the system and method will automatically check if the student is female and register them in the Math course if it exists. Without the system and method, every program that inserts a student (row) into the Student table needs to implement the constraint. If even one such program does not correctly implement the constraint, the data may be corrupted and no longer be valid.

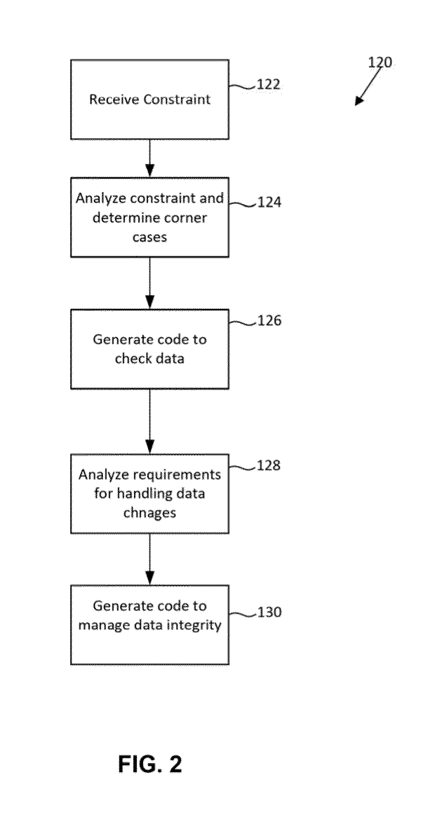

FIG. 2 is a flow chart illustrating a method 120 for managing data integrity, and in particular, for translating constraints, according to an embodiment.

The Constraint Translator module 102 receives at least one constraint, at 122, for example from a constraint author, such as an end user 10.

At 124, the analysis component 114 analyzes the constraints and determines whether all corner cases are handled by the constraints; otherwise the system 100 reports an error to the constraint author and stops.

At 126, the analysis component 114 generates code that checks the constraints and makes further changes to the previously stored data to restore the data to a valid state that satisfies the constraints. In some cases, the Constraint Executor module 104 may execute this code immediately or soon after the conde has been generated by the analysis component 114.

At 128, the analysis component 114 further analyzes the requirements for any new or additional insert, update or delete to a row in any table, and prepares separate code for each case where constraints may need to be validated and/or data changes may be made, generating code for each insert, update or delete change.

At 130, the Constraint Translator module 102 generates and outputs a program to manage data integrity in view of the at least one constraint. It is intended that the Constraint Executor module 104 may run the program generated by the Constraint Translator module 102.

From the method 120 for managing data integrity, generally, constraints are read, for example, from some textual representation, and using known techniques, the constraints are translated into a data structure suitable for further analysis and modification in subsequent steps. In one embodiment, a graph is created representing the constraints.

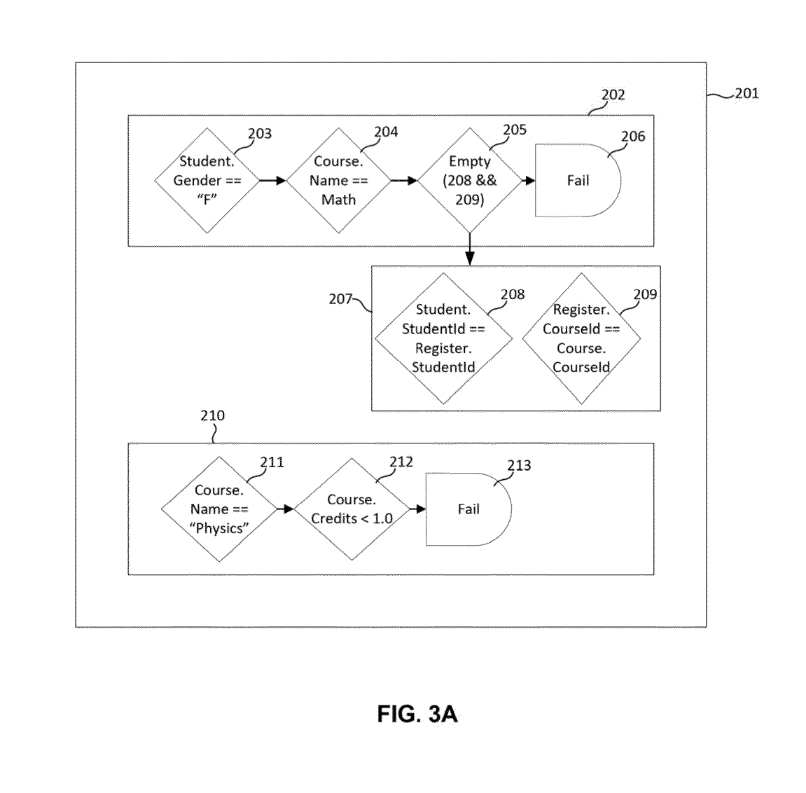

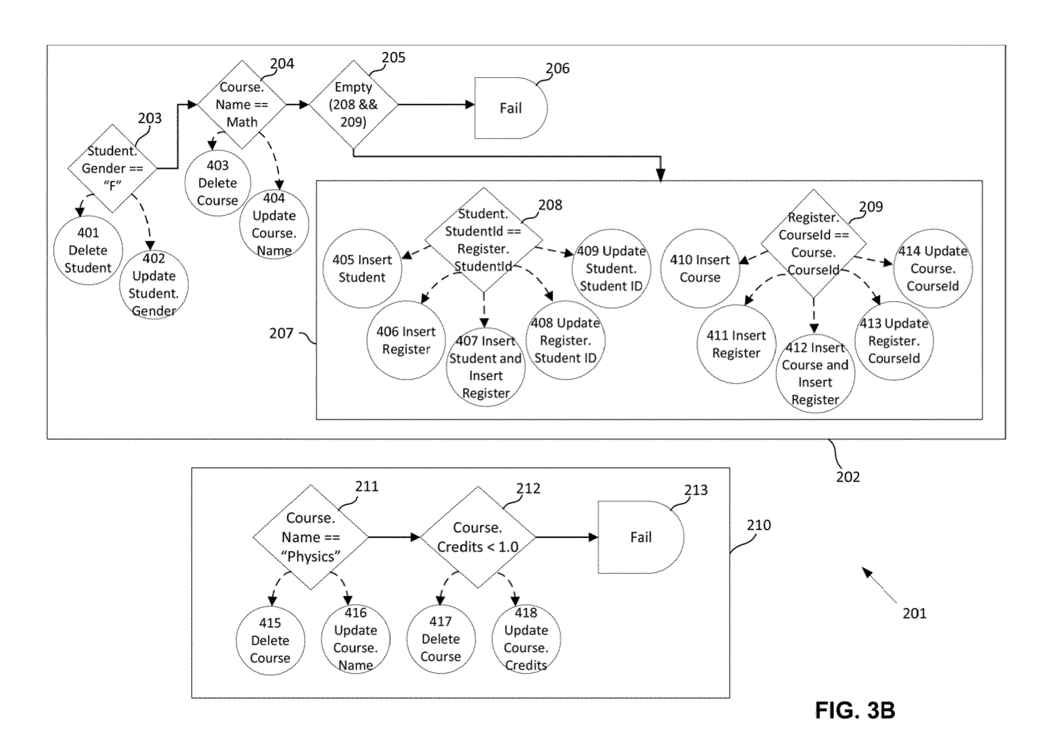

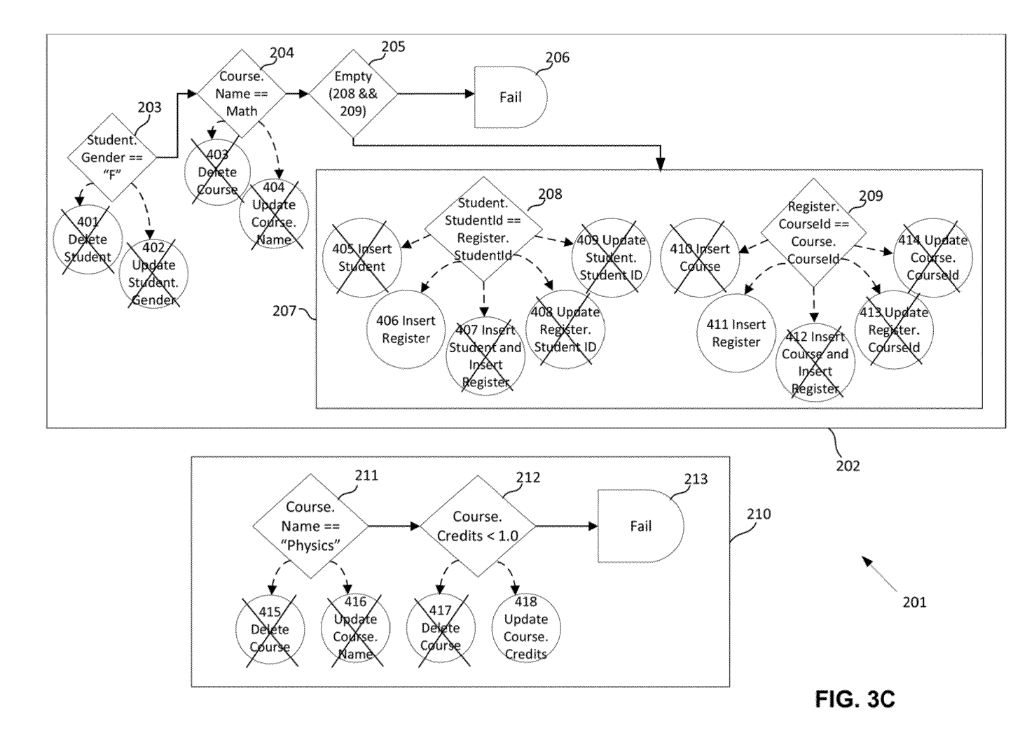

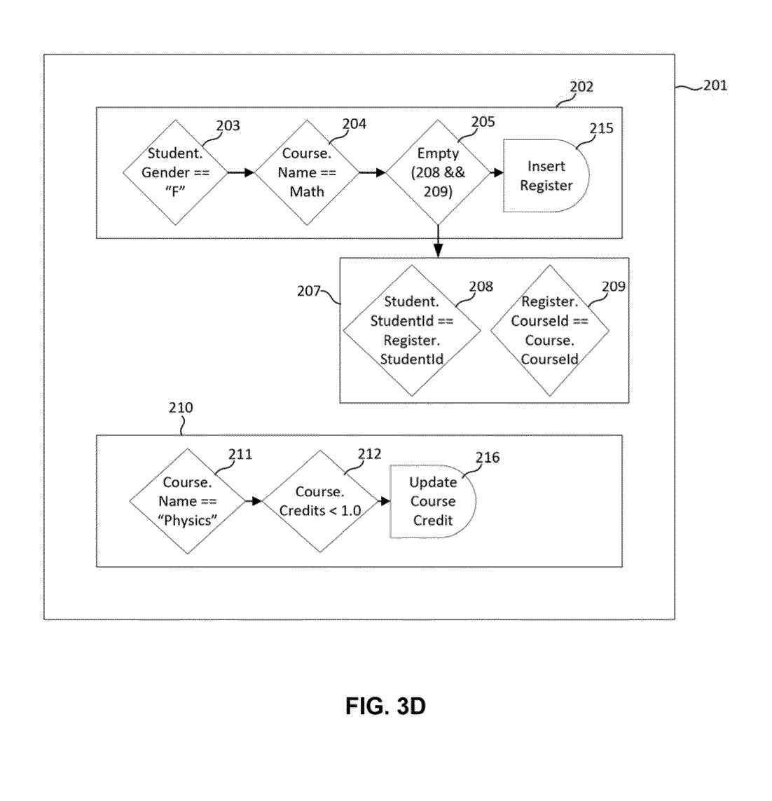

FIG. 3A shows a graph created for the two constraints considered earlier, the first being that if there is a math course, all females must be registered for that course, and the second that all physics courses must be at least one credit.

The two constraints are grouped together into a sequence 201 of sub-constraints. Each constraint is represented by nested sub-constraints 202 and 210. The first constraint 202 includes conditions and sub-conditions 203 through 209 and can be read as “if the student is female, then if the course is math, then if there are no rows in the Registration table for the corresponding student and course, then fail”. The “And” condition 207 is actually contained in the Empty condition 205 but is illustrated separately in FIG. 3A for legibility. The original assertion, phrased as “assert(condition)” has been translated to “if (condition is false) fail”. Similarly the second constraint 210 includes conditions 211 through 213 which represent a failure if the course is Physics and the number of credits is less than 1.

Fail conditions 206 and 213 along with the preceding conditions 203, 204, 205, 208, 209, 211 and 212 represent the corner cases for the two assertions. The goal of the Constraint Translator module 102 is to transform this graph into one with similar structure but containing insert, update or delete operations instead of Fail. In some cases, the Constraint Translator module 102 may completely replace Fail with such a change, thus completely eliminating the entire corner case leading to Fail. In other cases, such as the first assertion shown which had a corner case if there is no Math course, the Constraint Translator module 102 may replace the Fail with two separate items in the sequence, one that allows for the change and the second that still has a Fail in the corner case.

The Fail condition 206 occurs if the conditions 203, 204, and 205 all occur. Therefore, to prevent the Fail condition 206 from occurring, it suffices to negate any one of the conditions 203, 204, and 205. FIG. 3B shows each of the conditions, and the operations that the Constraint Translator module 102 could employ to negate the conditions. Consider condition 203: a student is female, which is intended to be the same as saying the Student table has a row where the Gender column has value “F”. To make this no longer be the case, the Constraint Translator module 102 could employ fix operation 401, delete the row from the Student table, or fix operation 402, update the Gender column so that its value is something other than “F” (for example, “M”). Though these solutions might appear illogical, in the sense that “If a student is enrolled in a school, she cannot simply be un-enrolled from the system” and “If a student is female, it makes no sense to label her in the system as male”, these solutions are nonetheless possible ways of negating condition 203.

Similar logic explains how condition 204, “there is a row in the Course table whose Name column has value “Math””, can be negated by fix operation 403, delete that row from the Course table or fix operation 404, rename that value to something other than “Math”.

With Empty condition 205, there are sub-conditions 208 and 209 to be considered. In a specific example, a row in the Student table has Gender “F”, and has a particular StudentId value, denoted S. If there are no rows in the Register table where the value in the StudentId column is S (which is a way of stating condition 208), then fix operation 405 through 409 are possible ways of negating that condition. Similarly, for a row in the Course table with Name “Math” that has CourseId C, if there are no rows in the Register table where the value in the CourseId column C, condition 209, then fix operations 410 through 414 are possible ways of negating that condition. Finally, condition 211 can be negated by fix operations 415 or 416, and condition 212 by fix operations 417 or 418. All of these potential solutions to negating the conditions are illustrated in FIG. 3B.

The Constraint Translator module 102 can only pick solutions that the constraint author has allowed using annotations (the apostrophe notation). In the case of the female students enrolled in math, the apostrophes were on the Register table, meaning that only inserts or deletes into the Register table are allowed. In the case of the physics course worth less than 1 credit, the apostrophe was on the Credits column of the Course table, meaning only updates to the Credits column of an existing row of the Course table are allowed. Thus, in FIG. 3C, the only legal solutions for the first assertion are fix operation 406 and fix operation 411, and for the second assertion, fix operation 418. In plain English: for each female student, if there is a math course, a row must be inserted into the Register table for that student and that course; for the physics course, the Credits column must be set to a value 1 or larger. These fixes are illustrated in FIG. 3D, where Fail 206 has been replaced with the insertion into Register, and Fail 213 has been replaced with the update to Course.Credits. There are no more Fails left in FIG. 3D, meaning all Corner Cases have been resolved.

Table 1 below illustrates the nodes and possible fixes as defined in FIGS. 3A to 3D.

| Node | Possible Fixes |
|---|---|
| 203 Student.Gender == “F” | One of: |
| | 401 Delete(Student) |
| | 402 Update Student.Gender = X where X is not “F” |
| 204 Course.Name == “Math” | One of: |
| | 403 Delete(Course) |
| | 404 Update Course.Name = Y where Y is not “Math” |
| 208 Empty(Student.StudentId == | One of: |
| Register.StudentId) | 405 Insert Student(StudentId=Register.StudentId) (if |
| | at least one row in Register table) |
| | 406 Insert Register(StudentId=Student.StudentId) (if |
| | at least one row in Student table) |
| | 407 Insert Student(StudentId=[make one up]) and |
| | Insert Register(StudentId=[made-up StudentId]) |
| | 408 Update Register.StudentId = Student.StudentId |
| | (if at least one row in each of Student and Register) |
| | 409 Update Student.StudentId = Register.StudentId |
| | (if at least one row in each of Student and Register) |
| 209 Empty(Register.CourseId == | One of: |
| Course.CourseId) | 410 Insert Course(CourseId=Register.CourseId) (if |
| | at least one row in Register table) |
| | 411 Insert Register(RegisterId=Course.CourseId) (if |
| | at least one row in Course table) |
| | 412 Insert Course(CourseId=[make one up]) and |
| | Inert Register(CourseId=[made-up CourseId]) |
| | 413 Update Register.CourseId = Course.CourseId |
| | (if at least one row in each of Course and Register) |
| | 414 Update Course.CourseId = Register.CourseId |
| | (if at least one row in each of Course and Register) |
| 211 Course.Name == | One of: |
| “Physics” | 415 Delete(Course) |
| | 416 Update Course.Name = Z where Z is not |
| | “Physics” |
| 212 Course.Credits < 1 | One of: |
| | 417 Delete(Course) |
| | 418 Update Course.Credits = W where W >= 1 |

For the example above, there is generally one solution. Cases will occur where more than one solution is possible and allowed, in which case it is generally sufficient to choose one such solution via an appropriate algorithm or heuristic. In some cases when more than one solution is possible, the system may have predetermined preferences, for example, the system may prefer updates over inserts or deletes, and inserts over deletes, or prefer solutions with fewer changes. If, after selecting solutions in the predetermined order, there are still more than one equally acceptable solution, the system 100 may select a solution at random or by another selection method.

The process is intended to apply to constraints of arbitrary complexity: creating a list of possible solutions, reducing the list by considering the annotations on the constraints then choosing a solution.

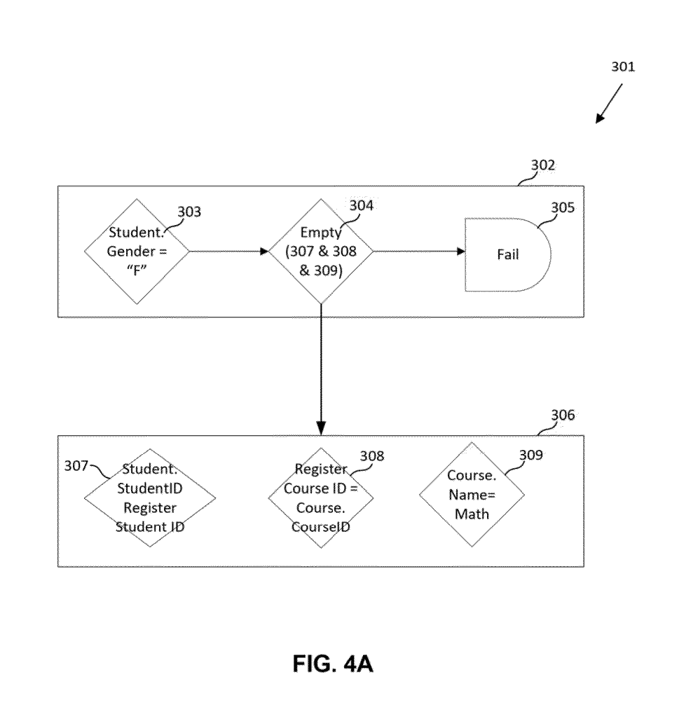

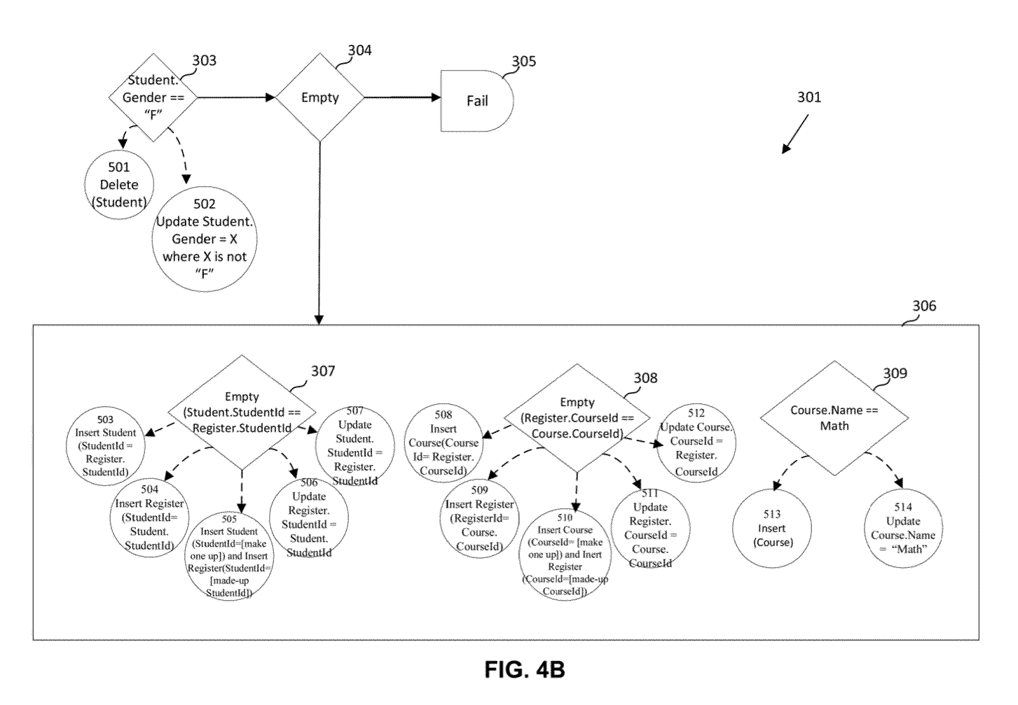

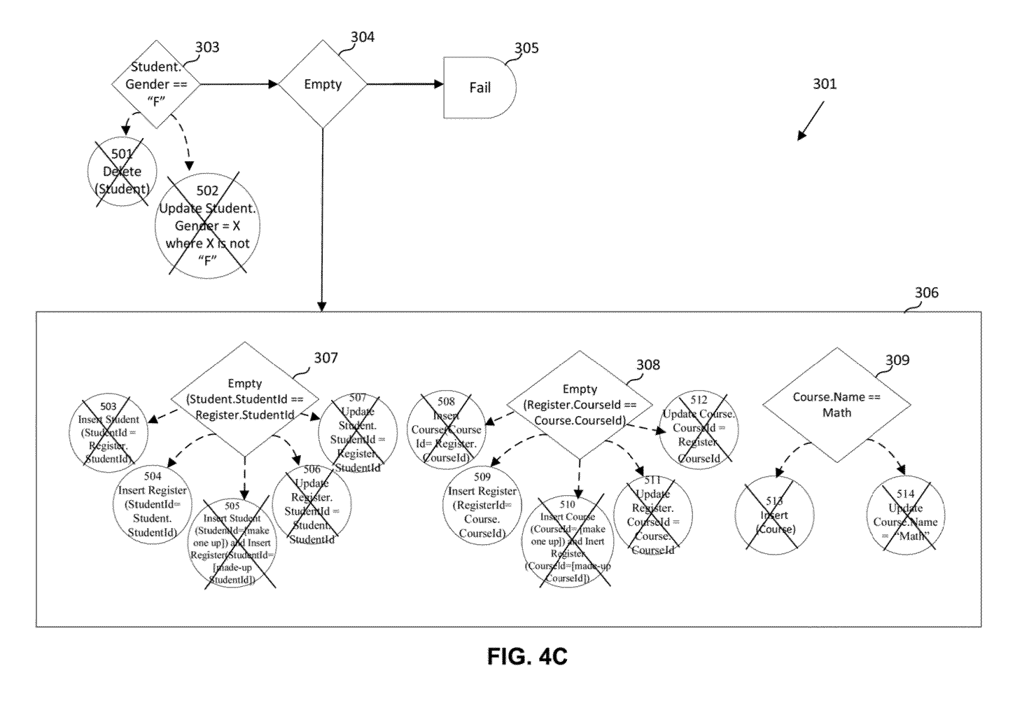

Now consider the constraint in FIG. 4A, illustrating a second sequence 301, which is the original constraint that did not properly handle the case when there is no Math course. FIG. 4A is similar to the top portion of FIG. 3A, but the condition on the Math course 309 is now part of the Empty test 304. Otherwise, the conditions are the same: the student gender condition 203 has become condition 303, the student ID condition 208 has become condition 307, the course ID condition 209 has become condition 308, and Fail condition 206 has become Fail condition 305.

Table 2 shows the possible operations that the Constraint Translator module 102 could employ to negate Fail condition 305. These are illustrated in FIG. 4B. As before, the Constraint Translator module 102 can only pick operations that the constraint author has allowed using annotations. In FIG. 4C, forbidden operations are shown crossed out, and allowed operations are left uncrossed. It is possible to resolve constraint 307 with operation 504, inserting into the Register table. Likewise, constraint 308 can be resolved with operation 509, inserting into the Register table.

TABLE 2

| Node | Possible Fixes |
|---|---|
| 303 Student.Gender == “F” | One of: |
| | 501 Delete(Student) |
| | 502 Update Student.Gender = X where X is not “F” |
| 307 Empty(Student.StudentId == | One of: |
| Register.StudentId) | 503 Insert Student(StudentId=Register.StudentId) (if |
| | at least one row in Register table) |
| | 504 Insert Register(StudentId=Student.StudentId) (if |
| | at least one row in Student table) |
| | 505 Insert Student(StudentId=[make one up]) and |
| | Insert Register(StudentId=[made-up StudentId]) |
| | 506 Update Register.StudentId = Student.StudentId |
| | (if at least one row in each of Student and Register) |
| | 507 Update Student.StudentId = Register.StudentId |
| | (if at least one row in each of Student and Register) |
| 308 Empty(Register.CourseId == | One of: |
| Course.CourseId) | 508 Insert Course(CourseId=Register.CourseId) (if |
| | at least one row in Register table) |
| | 509 Insert Register(RegisterId=Course.CourseId) (if |
| | at least one row in Course table) |
| | 510 Insert Course(CourseId=[make one up]) and |
| | Inert Register(CourseId=[made-up CourseId]) |
| | 511 Update Register.CourseId = Course.CourseId |
| | (if at least one row in each of Course and Register) |
| | 512 Update Course.CourseId = Register.CourseId |
| | (if at least one row in each of Course and Register) |
| 309 Course.Name == “Math” | One of: |
| | 513 Insert(Course) |
| | 514 Update Course.Name = “Math” |
| | (if at least one row in Course) |

However, constraint 309 has no legal resolution (both operation 513 and 514 are forbidden). Thus, there is no way to resolve all three conditions in the constraint 306, and thus there is no way to negate Fail condition 305. Another way to state this is, there is a corner case which cannot be resolved. The corner case, in plain language, occurs when the Math course does not exist: the Constraint Translator module 102 can perform no operations to resolve this situation.

Had there been an annotation (an apostrophe) on the Course, then the Constraint Translator module 102 would have been allowed to insert a row into the Course table, and the corner case would have been resolved. Had, instead, there been an annotation on Course.Name, then the Constraint Translator module 102 would have been allowed to modify the name of a course from its existing value to “Math” as long as there was another row in Course, and the corner case would have been narrowed to the case where the Course table has no rows. Without these annotations, the Constraint Translator module 102 can report to or notify the constraint author that an unresolvable corner case exists, as well as the nature of the corner case (i.e., when there is no Math course, the assertion cannot be satisfied). The constraint author can then modify the constraint or assertions to resolve the corner case.

The system 100 now takes the graph in FIG. 3D as a solution for the passive mode of the Constraint Executor module 104. For the reactive mode, the Constraint Translator module 102 determines the possible impact of a single Insert, Update or Delete from any of the tables mentioned in the graph, and produces a specialized graph for each. For example, consider the insert of a new Student in FIG. 3D. For Nested constraint 202, the condition 203 becomes a condition whether the newly inserted Student has Gender equal to “F”, and the condition 208 on StudentId becomes a condition for the StudentId of the newly inserted student. The other conditions 204, 205 and 209 are unchanged. There is no possible impact on the second Nested constraint 210 so no action is required there. Thus the action after inserting a new student S is:

```
    if (S.Gender == “F” && Course.Name == “Math” &&
      empty(Register.StudentId == S.StudentId &&
Register.CourseId==Course.CourseId)
      Insert Register(StudentId=S.StudentId, CourseId=Course.CourseId)
```

The Constraint Translator module 102 reviews the collection of graphs and generates code based on the graphs. One skilled in the art can see that the graph element types Sequence, Nested, Exists, Empty, Test, Fail, Insert, Update and Delete generally map to concepts in computer languages and can be translated into an appropriate computer language, and in an appropriate format such as source code form, physical machine code, virtual machine code, or the like.

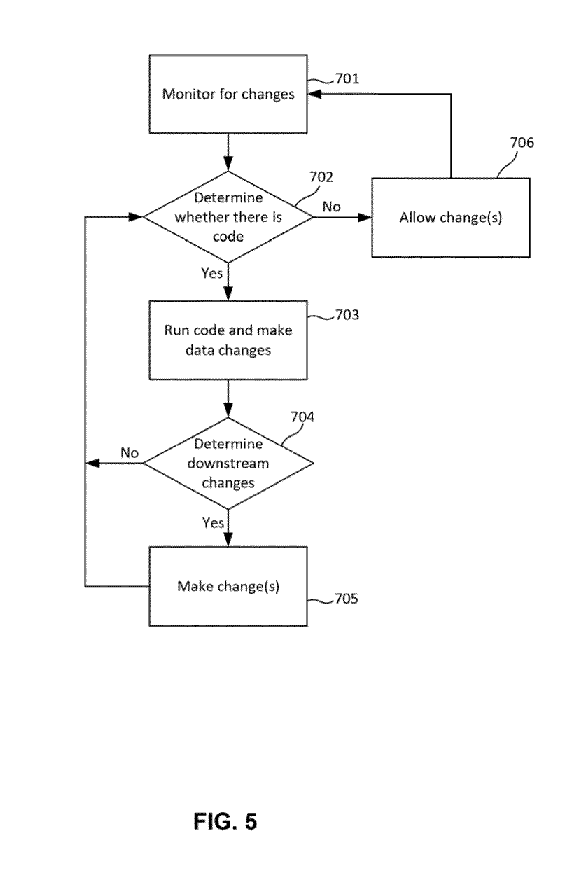

FIG. 5 is a flowchart illustrating a method 700 for managing data integrity according to an embodiment, and in particular for managing data changes.

At 701, the monitoring component 114 monitors for data changes. In some cases, the Transmitter module 106 may monitor for changes and notify the monitoring component 114 of the data change. This notification can come via numerous mechanisms common in the practice, including but not limited to call-backs, triggers, and polling.

At 702, when a change is noticed, the Constraint Executor module 104 determines whether the Constraint Translator module 102 has previously produced code to handle this type of change. In the example above, the Constraint Translator module 102 produced code for an update to a row in the Student table, or the deletion of a row in the Course table.

If there is code, at 703, the modification component 116 runs the code to modify the data. The code may produce downstream changes. If there is no code, at 706, the system allows the changes as the data does not invalidate any constraint.

At 704, the Constraint Executor module 104 determines whether there are any downstream changes. If there are no downstream changes, the system 100 determines there is no further code and allows the changes, at 706.

At 705, the modification component 116 modifies the data based on any determined downstream changes. After applying the changes to the data, the Constraint Executor module 104 determines whether there is further code to be executed.

At 706, if there are no more code to be executed, the system 100 determines that the changes are allowed and the data has been returned to a valid state. The system 100 monitors for further changes. It will be understood that the system 100 may monitor continuously for data changes and may monitor for changes as it is executing code related to previous changes made.

If, in some cases, the changes never stop it may be that the system determines there is an infinite loop. Infinite loop detection is generally acknowledged as a difficult problem. Some infinite loops can be detected by analyzing the constraints. As a trivial example, the constraints “All students are male” and “All students are female” obviously conflict, and can be detected when analyzing the constraints. The Constraint Translator module 102 may choose to implement any number of infinite loop detection mechanisms, or none.

Generally speaking, the embodiments of the system and method herein provide a system and method that allows constraints to be specified on data, for example, data involving one or more tables. In a particular case, the constraints can be annotated to indicate which data can be modified to satisfy the constraints. In this case, the system includes a module to identify where the constraint specification doesn't handle all cases, or alternatively, the system includes a module that identifies all possible data modifications that could invalidate those constraints. The system also includes a module that identifies follow-on data modifications and related computations intended to ensure the constraints are satisfied. The system is configured to generate computer programming code that can be executed by a processor that implements the data modifications needed based on the constraints.

In some cases, the embodiments of the system and method for data integrity may be used with data in computer networks and more particularly with network topology discovery.

A system and method for network topology discovery may be intended to automate both the discovery of a network of computing devices, and the visualization of the network. In general, “Discovery” means determining the devices that are connected in the network, and determining how they are connected. “Visualization” means displaying the network (the devices and connections) in one of several manners that are intended to be comprehended by a human.

An example of a network of computing devices can be found in modern homes. Many houses in Organisation for Economic Co-operation and Development (OECD) countries have Internet service, which is provided via a telephone line, cable television line, fiber optic cable, satellite link, or other method. The Internet connection generally enters the house via a modem, and the modem is often connected to a Wifi-compatible (For example, IEEE 802.11) router. Frequently, other devices inside the house, such as computers, laptops, tablets, gaming consoles, handheld gaming devices, smartphones, and media servers, connect to the Internet through this router, either wirelessly or using a physical wire (such as an Ethernet cable).

A home network is typically relatively simple, for a number of reasons. For example, in a home network, most of the devices in the home do not attempt to communicate with each other: they merely wish to access the outside Internet, through the shared connection point (the modem). Moreover, devices are not added or removed very often: the set of devices connected in the network remains relatively constant (except, perhaps, for smartphones, which leave the house in the morning with their owner and return in the evening).

More complicated networks of computing devices are found in businesses. A business with, for example, 50 employees will have a computer of some kind (perhaps more than one) for each employee. There might be servers, that include, for example, an employee database or a manufactured parts database, which are accessible from their computers by some employees but not others. Each employee might have one or more mobile devices (like a smartphone or a tablet) which also connect to the company network. Modern businesses might use Internet Protocol (IP) based desk telephones, which also use the internal data network. Ensuring all these devices can connect to the Internet, or each other, will likely require more than one switch or router. Businesses that span multiple offices will generally have a local network for each office, but devices within one office might need to communicate with devices in another office. Thus, a business typically includes many more devices, and many more types of devices, than a typical home.

Generally, the larger the business, the more devices that connect to the network, and hence the greater the complexity of the network: more devices means more possible connections between devices, and more interactions among devices. Not only does the number of devices grow, but the rate of change of devices grows. For example, a company with 1000 employees will have new employees joining, and old ones leaving, more often than a company with 10 employees. Computers for new employees must be provisioned on the network, while computers for old employees must be removed.

In a business, the job of managing the network often falls to one or more individuals in the information technology (IT) department. The network manager is in charge of ensuring that devices can communicate with each other, and the outside world, according to the policies of the business. This entails two things: knowing the inventory of network devices, and understanding their topology (how they are connected, both physically and logically).

A network manager might maintain a physical wiring diagram, showing where network connection points exist, and which devices are connected to them. There might also exist a logical network diagram, explaining how various device categories are restricted from, or allowed to, communicate with other devices. However, maintaining diagrams by hand becomes increasingly difficult as a network grows: the rate of change of devices and connections can be too great to keep up with. Consequently, hand-drawn (or, in general, human-maintained) network diagrams are frequently out of date, and onerous to keep up to date.

The following disclosure relates to a system and method for network topology discovery that are intended to help a network manager stay abreast of changes in the network. In real time, the system and method are configured to discover new devices, notice when old devices disappear, find connections (both physical and logical) between devices, notice when those connections change, and display the network in a number of ways.

In one aspect of the system and method for network topology discovery, there is provided a software program that runs on a computer inside the network to be managed. The software program is intended to work with no end user input, meaning the software program operates completely autonomously.

Before describing the system and method for network topology discovery further, the following terms and concepts are used in the following description.
A *network device* (or *device*, for short) is a piece of equipment with one or more *interfaces* (a “port” where network *traffic* can be sent and received). One or more of the interfaces are *connected* to other network devices; devices can communicate directly with one another, for example when directly connected or indirectly through other network devices.
The collection of devices and interface connections comprises the *network*. It is this network that the system and method attempts to *discover*; the process is termed *network discovery*. Network discovery generally comprises two parts. The first is device discovery, where all existing devices and their interfaces are inventoried. The second is topology discovery, where the physical and logical connections between the devices are determined.
In many cases, a device is capable of at least three things: (a) executing a program, (b) responding to queries about its configuration, and (c) responding to queries about its state. Examples of such devices are computers (like PCs and Macs), and routers and switches (such as those made by Cisco™, HP™, Juniper™, and Huawei™). However, not every device is capable of all three things. For example, a *hub* is a “one to many” connector: it allows an interface on one device to connect to multiple different interfaces on other devices. Often, hubs are simple devices on which no programs can be executed, and which do not respond to any external queries.
Not all devices are physical devices. For example, a PC or Mac computer (one that can be touched or carried around—a physical machine) can contain one or more *virtual machines*. These are typically programs that run on the computer, and which behave like a completely separate computer. Virtual machines can act as network devices: even though they are a program that runs inside a physical computer, they act as though they are independent network devices.
Often, an interface on one device is physically connected to another interface (for example, using an Ethernet cable). However, not all interface connections are physical. For example, a wireless interface connects to another wireless interface over the air, sometimes using a radio-based protocol. It is possible for many devices to connect to a single wireless *access point*: such connections are not *one to one*, but *many to one*.

In its most general form, device discovery is an iterative process. For any device which is discovered, if it is possible to query the device about its interfaces and connections, then this information can be used to discover additional devices, some or all of which may in turn be queried, and so on. Eventually, network discovery reaches a steady state, where all devices that can be discovered have been discovered: at that point, network discovery is said to be *complete*.

### Discovery

The discussion which follows explains the details of device discovery, and discusses an embodiment of a system and method for device discovery.

### Agent and Initial Device

In this embodiment, a network discovery executable program, the *agent program* or *agent*, is downloaded onto one of the devices, the *initial device*, inside the network to be discovered, the *target network*. The initial device must be connected to at least one other device in the target network; if it weren't, then the target network cannot be discovered.

In some cases, the initial device is a computer (for example, a PC, Mac, or Linux machine) which is capable of running a virtual machine, and the agent is a *virtual machine image* that can be executed by a virtual machine running inside the initial device.

### IP Networks

The vast majority of internal networks (and, indeed, much of the Internet) identify their network devices using *Internet Protocol* addresses (or *IP addresses*) [RFC791]. The system and method herein do not require a network to be an IP network, but for the purposes of this discussion, an IP-based the target network for ease of illustration.

The most common form of IP address is so-called *version 4* (*IPv4*), where an address is written in *dotted decimal* notation: four numbers, each between 0 and 255, separated by periods. For example, 1.2.3.4 and 76.255.0.131 are valid IPv4 addresses.

IPv4 distinguishes *private addresses* from *public addresses*. A public address is intended to be reachable by any device which is connected to the Internet; a private address is intended to not be reachable from outside a private network, and it can be reached by other devices with private addresses on a private network. A device with a private address can generally reach a public device, so long as there is a *network address translation device* (or *NAT device*), which is a specialized network device that allows connections from a private address to a public one.

In IPv4, any dotted decimal address beginning with 10, or 192.168, or any address in the range from 172.16 to 172.31, is defined to be private. All other addresses are public.

There is also Internet Protocol version 6 (IPv6), whose use is becoming increasingly common. Its addresses are written as 32 hexadecimal digits (0 through 9 and A through F), with every group of four digits separated by a colon. IPv6, too, defines a private address as one whose first two hexadecimal digits are FD.

The agent is configured to distinguish between private addresses and public addresses, and, in this embodiment, it is configured to discover only internal network devices (those with private addresses). Otherwise, it would attempt to recognize every public device, which would result in it “scanning the Internet”, which is usually not desired. Alternatively, the agent may be configured to scan for private addresses and some subset of additional addresses beyond the private network.

### Identifying an Address Range for Discovery

The initial device is connected via an interface to one or more other devices. That interface has an address associated with it. When operating on IPv4 addresses: such addresses have two components, an *address* component and a *netmask* component.

A netmask represents a group of addresses. It is best explained by realizing that the dotted decimal IPv4 notation can also be represented as a hexadecimal (base 16) number with 8 digits in it. As an example of how to write a dotted decimal IPv4 address as hexadecimal, consider the address 10.0.77.131. Each number is converted to base 16 and then written consecutively: 10 in base 10 is 0A in base 16, 0 is 00, 77 is 4D, and 131 is 83, meaning 10.0.77.131 is the same as 0A004D83.

That base 16 number can be considered a 32-digit binary (base 2) number. A netmask can also be thought of as a 32-digit binary number, consisting of one or more binary 1 digits, followed by binary 0 digits. One simple way to describe a netmask is using *slash notation*, like /24: this means the netmask is 24 binary 1s followed by 8 binary 0s. In base 16, therefore, a /24 netmask is written FFFFFF00. Likewise, a /29 netmask is 29 binary 1s and 3 binary 0s, which is written FFFFFFF8 in base 16.

A netmask of /X, where X is a number from 0 to 32, describes the group of IPv4 addresses whose first X binary digits are fixed, and whose remaining binary digits (of which there are 32 minus X, or (32−X)) can vary. Such a netmask contains two to the power (32−X) addresses. So, a /24 netmask represents a group with 2 to the power (32−24), or 2 to the power 8, or 256, addresses. A /15 netmask represents a group with 2 to the power (32−15), or 131072, addresses. A group of addresses is often called a *subnet*.

Thus, the subnet 10.0.77.131/24 contains all IP addresses whose first 24 binary digits are the same, and whose last 8 binary digits vary. In other words, 10.0.77.131/24 is the group of 256 addresses from 0A004D00 base 16 to 0A004DFF base 16. In dotted decimal notation, it is the group of addresses from 10.0.77.0 to 10.0.77.255.

Similarly, the subnet 10.0.77.131/29 represents the group of eight IP addresses from 0A004D80 to 0A004D87 in base 16 notation, or 10.0.77.128 to 10.0.77.135 in dotted decimal notation.

A subnet is sometimes used as a convenience for humans, in order to help identify devices that are considered part of the “same group”. For example, for all of the desktop computers in a company, the network manager may decide that they be assigned an IPv4 address from the subnet (i.e., pool of addresses) 10.8.3.0/25 (so, one of the addresses in the range 10.8.3.0 to 10.8.3.127). This assumes that there are 128 or fewer desktop computers in the company; if there were more, then the /25 netmask could be changed to /24, doubling the size of the pool.

In an IPv4 network, the netmask is part of the IPv4 address assigned to a device. This implies there is a group of addresses which might be assigned to other network devices, as in the desktop computer example. Thus, if the agent finds an interface with an IPv4 address of 10.18.3.194/26, it can infer that this network device is part of a group of up to 64 devices whose addresses range from 10.18.3.192 to 10.18.3.255.

Thus, the agent has a starting point for network discovery: it can scan the addresses in this range. A discussion of scanning is found after the following section.

### Routing and Gateways

An important concept in networks in general, and IP networks specifically, is that of *routing*.

On a network, not every device is generally connected (either physically, or via wireless or the like) directly to every other device. However, two devices (called endpoint devices for this example) which aren't directly connected can still communicate via intermediate devices. Each intermediate device comprises a *hop* along a *route* between the endpoint devices. Routing is the action of determining the *next hop* towards a particular endpoint device.

A device with multiple interfaces has a *routing table*. This is a set of rules which says, for traffic destined for a particular address, one of two things: which address the traffic should be sent to, or which interface the traffic should be sent out of. The address to which traffic is sent is often called a *gateway*. Often, the routing table contains a *default route*: for traffic destined for an address that is not listed in the table, using a particular gateway (i.e., address). A second rule in the routing table says for traffic destined for that gateway, use a particular interface.

A device with only a single interface does not technically need a routing table, since obviously, traffic can only flow out of the single interface; however, frequently such devices have routing tables anyway.

For example, a particular computer at a company might have two interfaces, which might be denoted F and G. Interface F might be connected to a server machine, including, for example, an employee database, and interface G is for all other traffic. The routing table for such a computer would specify that traffic destined for the address of the employee database machine uses interface F as the gateway, while all other traffic (for example, to the public Internet) uses interface G. Thus, interface G is the default route.

The address of the default route in a routing table is a second starting point for network discovery. The agent can examine the default route of the initial device; that tells the agent the address of the next hop device. The agent can then attempt to probe the next hop device using its (now known) address. Often, but not always, the next hop is part of the initial device's subnet.

### Scanning and Querying

An agent that has learned of a subnet can use multiple techniques to attempt to determine which addresses in the subnet contain devices. When the agent employs these techniques on every address in the subnet, this is called *scanning* the subnet. These techniques are used for the purpose of collecting *evidence* about the existence (or nonexistence) of a network device. In IP networks, an agent can send IP *packets* (collections of sequences of data bytes) to potential addresses.

When the agent obtains evidence of the existence of a device, it can add that device's address to the inventory of network devices. Moreover, it might be able to query that device to obtain further subnets or addresses at which devices might exist: in other words, it allows *iteration* (the repeated scanning and querying) towards convergence (a complete map of the network). One specific technique is to send Internet Control Message Protocol (ICMP) *echo request* packets (often called *ping* packets) to every address in a subnet. A second technique is to send Transmission Control Protocol (TCP) synchronization (SYN) packets to various *listening ports* on a given address. A third technique is to send Simple Network Management Protocol (SNMP) User Datagram Protocol (UDP) packets to a listening port on a given address. A fourth technique is to use the Telnet or secure shell protocols to attempt a TCP connection to a device, and to use its *command-line interface* (CLI) to query it.

### ICMP Ping Scanning

A large number of network devices are “listening” for ICMP ping packets. Such a packet, in effect, asks the network device, “Are you alive?” In this context, “listening” means there is a program running on the network device whose job is to monitor interfaces for data packets which conform to the ICMP ping format. The listening program will cause the network device to respond to the ping packet by emitting an *echo reply* packet (sometimes called a *pong* packet).

An embodiment of an agent sends out an ICMP ping to every address in a subnet; for every address for which it receives a pong response, the agent has evidence that a network device exists at that address. Not all network devices respond to pings, so if a given address does not reply with a pong, this does not mean that there is certainly no device at that address; it merely means further scanning of that address using a different technique might be required to reveal the presence of a device at that address.

### TCP Port Scanning

TCP is the workhorse of the Internet today: two endpoint devices, such as a laptop and a website computer, use TCP *sessions* (sequences of packets) to communicate with one another. TCP is one of the *layers* that comprise a packet; just as IP defines the address of a network device, TCP defines a *listening port* (or simply *port*, for short), which is a number between 0 and 65535.

A listening port is associated with an application program. For example, a web server (which runs an application program which implements the Hypertext Transfer Protocol, or HTTP) will often “listen on” port 80, which means the application program waits for endpoint devices to “connect to it” by sending a TCP SYN packet “to port 80” on the web server. By contrast, an email server (which runs an application program which implements the Simple Mail Transfer Protocol, or SMTP) will often listen on port 25.

There are various “well-known” port numbers, such as 80 for HTTP and 25 for SMTP, defined by various Request For Comment (RFC) documents published by the Internet Engineering Task Force (IETF). In this type of scanning an agent sends out TCP SYN packets to well-known port numbers for each IP address in a subnet; if the agent receives back a TCP SYN/ACK packet, acknowledging its SYN packet, then the agent has evidence that there is a device at the IP address.

### SNMP Scanning and Querying

Just as network devices are often programmed to listen for ICMP ping packets, some network devices listen for SNMP packets. SNMP packets use UDP instead of TCP: unlike TCP, which attempts to recognize when a packet is lost and to recover the missing information, no attempt is made to compensate when a UDP packet is lost. However, an agent can send an SNMP packet to each address subnet to be scanned; for every response, the agent has evidence that here is a device at the IP address. The well-known listening port for SNMP is UDP port 161.

Though the delivery of SNMP is not guaranteed, it has an advantage over ICMP ping and TCP SYN packets: SNMP can be used for querying the properties of a network device. A large number of *management information base* (MIB) documents describe many aspects of a device (its interfaces and properties, its routing table, and so on); an agent can use SNMP not only to ascertain the existence of a device, but also to discover further subnets and gateways to inventory, by querying a device about information in the appropriate MIB. Once again, any device which responds to the agent provides evidence that the device exists.

SNMP does require *credentials*: a device will only respond to certain *community strings* (passwords) embedded in the packet, and otherwise will not respond at all. It happens that many devices have a default “read-only” community string, the word “public”: this allows reading, but not altering, MIB values. Network devices sometimes have a read/write community string, which allows reading and altering of MIB values: this has the effect of reconfiguring the network device.

In this type of scanning an agent tries reading basic information from network devices using SNMP packets with “public” as the community string. Once the agent has ascertained the presence of a device at a particular address, the agent can *prompt* (ask the human operator of the initial device, on which the agent is running) for the community string, if “public” seems not to work.

### Command Line Interface Querying

TCP port 23 is a well-known listening port for the Telnet protocol. TCP port 22 is a well-known listening port for the secure shell (SSH) protocol. In this scanning, the agent attempts to establish TCP connections to potential IP addresses using Telnet or SSH. If such a connection to an address can be established, then there is evidence that a device exists at that address.

Often, a device allows Telnet or SSH connections to provide access to its command-line interface (CLI). A CLI permits commands to be issued to the device, both to read its configuration, and to alter its configuration. For example, on many Cisco devices, the CLI command “show running-config” will display information about how the Cisco device is configured.

Output from CLI commands is often more human-friendly than the output from SNMP. Moreover, SNMP does not necessarily define a MIB for all possible configurations of a device; a CLI can provide access to more state and configuration information than SNMP alone. And, not all devices *populate* every MIB; for example, there exists a MIB for the routing table, but that MIB might not be populated (i.e., it might return nothing when queried) on a device, meaning that a CLI might be the only way to get routing table information from the device.

Like SNMP, Telnet and SSH both require credentials. Unlike SNMP, there is not one default set of credentials for Telnet, although often, particular manufacturers have a set of “factory reset” credentials. For example, a brand new device might have a login name of “admin” and an empty password as its default credentials; another might have “admin” as the login name and “admin” as the password. Also like SNMP, credentials can be different, depending on whether the device is merely to be queried (“read only”), or whether its configuration is to be changed (“read/write”).

As such, the agent attempts to identify the manufacturer of a network device, for example, using SNMP (which has a MIB in which basic device information, such as the manufacturer, the software revision, and the physical location of the device). The agent contains a list of known factory reset credentials for various manufacturers and device models, and it attempts to use these credentials to gain access to the CLI for the device. The agent also contains a list of CLI commands for various devices, and a method for extracting the information by *parsing* (extracting information from the meaningful portions of) the CLI output. In other cases, the agent may prompt a user for the Telnet or SSH credentials for a device.

### Topology Discovery

While device discovery on its own can be useful, the present system and method also attempts to determine how the devices are connected.

Earlier, there was a discussion of the *layers* of a data packet, when we contrasted IP addresses (layer 3) with TCP and UDP port numbers (layer 4). There is a standard way of discussing the layers of a packet, the Open Systems Interconnection (OSI) model.

The lowest layer is the physical layer, and it is denoted layer 1.

The next layer is the data link layer (layer 2). Many modern interfaces are Ethernet interfaces: Ethernet is an example of layer 2. Ethernet interfaces have a *media access control* (MAC) address, which consists of twelve base 16 digits, or equivalently, 48 base 2 (binary) digits, or 48 bits.

The next layer is the network layer (layer 3). IP is an example of a layer 3 protocol. As noted previously, IPv4 uses 32-bit addresses, and IPv6 uses 128-bit addresses.

Layer 4 is the transport layer. TCP and UDP are examples of transport layer protocols. There are layers 5, 6, and 7 as well, but the layers above 4 are generally irrelevant for the discussion of topology.

### Topology Concepts

In a network, it is often important to know which interfaces are physically connected to one another, or put another way, “connected at layer 1”. For example, the Ethernet port on a printer might have a cable plugged into it, with the other end of the cable going to an interface on a router: the printer and router interfaces are said to be connected at layer 1. If the router is wireless (e.g. Wifi-capable), then it has a wireless interface, to which (for example) a wireless interface on a laptop might be able to establish a connection over the air. Even though there is no physical wire connecting the laptop to the router, a connection established via radio waves is still considered a layer 1 connection.

A layer 2 connection between two devices is a “logical connection”. In the simplest case, a layer 2 connection is exactly the same as a layer 1 connection. For example, if an interface on a computer is connected to an interface on a printer, then the only traffic that flows over that interface is from the computer to the printer, and vice versa. The printer and computer are physically connected to one another (at layer 1), and the only traffic that flows over the link is between those two devices and no other device, so they are also logically connected (at layer 2).

However, layer 2 connections do not always correspond exactly to layer 1 connections. For example, it is possible for multiple layer 2 connections to share a single physical connection. In Ethernet networks, a common way to achieve this is by using the IEEE 802.1Q standard, which defines *virtual local area networks* (VLANs). Sometimes traffic that conforms to this standard is referred to as being part of a “dot 1Q VLAN”, since the term “VLAN” is more general than IEEE 802.1Q; the “dot 1Q” part is added to distinguish the specific IEEE 802.1Q VLAN from some other kind of VLAN.

The Ethernet (layer 2) portion of data packet can include a *dot 1Q VLAN tag* (or simply *dot 1Q tag*), which is a number from 1 to 4095. All packets with the same VLAN tag are considered part of the same layer 2 network; two packets with different VLAN tags are considered parts of different logical (layer 2) networks. Packets can have no VLAN tag, as well, which yet another distinct layer 2 network (the “untagged network”).

For example, a stream of packets with dot 1Q tag 12 can be sent over the same physical wire as a stream of packets with dot 1Q tag 43, and those two streams are treated separately at layer 2, so long as the endpoint devices are programmed to handle dot 1Q VLAN tags. It is frequently useful to “share” two or more distinct logical (layer 2) traffic streams of traffic over the same physical (layer 1) connection, as in that example. Thus, dot 1Q tagging is a relatively simple way to “isolate” two traffic streams from one another, even when they share a physical wire.

It is also possible for multiple physical links to comprise a single layer 2 link. Such a group of links is sometimes called a *trunk* (another term, like VLAN, that can have multiple meanings), or *port channel*. This is useful when there is a sufficiently high volume of traffic between two devices that the traffic cannot be carried on a single physical wire (which has a maximum speed at which it can operate). The multiple physical (layer 1) connections act in unison logically (at layer 2).

It is even possible to combine port channels and dot 1Q tags. For example, five physical wires could form a port channel, and over that port channel, traffic with different dot 1Q tags can be sent. So, the five layer 1 wires are treated as one logical layer 2 connection, but that layer 2 connection has multiple distinct layer 2 traffic streams (distinguished by their dot 1Q tags) flowing over it.

Finally, layer 3 connections describe how network addresses can communicate with each other. The routing table, mentioned earlier, contains layer 3 connection information. As another example, layer 3 connection information may also be contained in an *access control list* (ACL). For example, suppose a sensitive database (like one containing employee payroll information) is connected to a particular router interface. Further, suppose that many employee computers (some from engineering, some from accounting, some from human resources) are connected to other interfaces on the same router. The router might have an ACL (a rule, enforced using software) which allows traffic to be sent to the database only from network addresses that are in a subnet for the accounting department computers. So, traffic is restricted at layer 3 (only particular network addresses may communicate with the network address of the database).

All three views of a network's connections (layer 1, 2, and 3) are useful in different ways for human understanding. The system and method described herein is intended to determine network topology information for each of these layers.

If the devices in the network are capable of being queried, via SNMP, or a CLI, or some other method and if the credentials (SNMP community strings, CLI logins and passwords) are either provided beforehand, or are unchanged from their default values, then the system and method herein can be configured to determine topology information autonomously: no end user input (prompting) is required while topology discovery is being carried out.

There are several sources of data of network topology information for an embodiment which operates in an IP network (by far the most common kind of network today). These sources are discussed below.

### Physical Layer Data Sources

Networking devices are often configured to transmit specialized data packets out each of their interfaces periodically. These packets contain information that identifies the network device name, the interface name, and other information. An interface on a different device which receives such a packet can process the packet, thereby determining information about its *neighbor* (the interface to which it is connected on the device which transmitted the packet).

The IEEE 802.1AB standard defines the *Link Layer Discovery Protocol* (LLDP), which is one such specialized format for a data packet. Certain vendors of networking equipment define their own proprietary packet formats, for example, *Cisco Discovery Protocol* (CDP), *Foundry Discovery Protocol* (FDP), and Microsoft's *Link Layer Topology Discovery* (LLTD).

Each of these protocols exists so that a device might determine its layer 1 connections: the device can be configured to send out and listen for LLDP (or one of the proprietary protocols), and to store LLDP information that it receives from its neighbors.

There are several SNMP MIBs which contain information about interface neighbors: the LLDP MIB, the Cisco CDP MIB, and the like. In embodiments of the system and method herein, the agent queries these MIBs on all devices using SNMP; if the MIBs are populated by a device, then the agent can determine the layer 1 connections associated with that device. As well, there is sometimes CLI output which contains layer 1 information; for example, on Cisco devices, the command “show cdp neighbor” presents a table of interfaces which have received CDP information from their neighbors. In this case, the agent determines layer 1 connections by parsing the output of an appropriate CLI command.

It is possible that some devices are not capable of transmitting any of these layer 1 protocols. And, even if a device is capable of transmitting and receiving (say) LLDP, it is possible for a network administrator to disable the sending of LLDP packets on the device. Moreover, not all devices populate one of the SNMP MIBs for layer 1 information; and, not all devices have a CLI command to display layer 1 information. As such, an agent may not be able to determine layer 1 topology from LLDP or a related protocol.

### The Forwarding Database

Certain network devices, specifically *switches* and *routers*, are typically designed with many interfaces (for example, 24 or 48), and they contain executable programs which switch (or route) traffic among the interfaces as needed.

In general, switching devices only consider link layer (layer 2) information when deciding which interface to send an arriving data packet out of. Routing devices can also use network layer (layer 3) information (like a routing table or an ACL) when deciding how to direct traffic.

Switching devices maintain an internal table of information called the *forwarding database* (FDB). This is a table which associates a link layer address (such as an Ethernet MAC address) with a physical interface on the switch. That is to say, the FDB associates layer 2 information with layer 1 information.

The idea is as follows. Suppose a new desktop computer is being connected into the internal network of a business. An Ethernet cable might be connected from the computer's Ethernet interface into (for example) interface number 17 on a switch. The switch will likely already have some other computers connected to other interfaces, and one or more switch interfaces will be connected to the rest of the network (for example, over a port channel to another switching or routing device).

Any data packet sent by the new computer contains layer 2 information. The first time the new computer sends a data packet out its interface, then: if the layer 2 protocol is Ethernet, part of the layer 2 information in the packet is the *source MAC address* (the MAC address, i.e., layer 2 address, of the computer's interface). The data packet will arrive at port 17 on the switch, whereupon the switch reads the source MAC address of the packet. Suppose the source MAC address (the MAC address of the computer's interface) is B8:E8:56:00:01:47. Then, the switch adds an *entry* (a row) to its FDB: the row says, “MAC address B8:E8:56:00:01:47 is associated with my interface number 17”.

Thereafter, if another computer on the network attempts to communicate with the new computer's interface, that other computer will send a packet whose layer 2 information contains a *destination MAC address* which matches that of the new computer's interface (i.e., B8:E8:56:00:01:47). When such a data packet arrives at the switch, it reads the destination MAC address, and then looks up that address in the FDB. In this example, it will find that MAC address and “interface 17” in the FDB. So, the switch knows to direct the packet out of interface 17, where it will be received by the new computer.

Contrast this to the case of a packet arriving at a switch for an unknown destination MAC address (i.e., a MAC address not in the FDB). Since the switch doesn't know out which interface to send the packet, the switch must *broadcast* the packet (send it out all of its interfaces). Most devices receiving this packet will *drop* (discard) it, since the destination MAC address doesn't match their interface's MAC address; only the device with a matching MAC address on its interface will process it.

This is inefficient, were it to be necessary for every single arriving data packet: on a 24 port switch, then a single arriving packet on one port would have to be transmitted out 23 other ports, whereupon it would be dropped by 22 of the devices connected to those ports. The FDB makes the switch (and all devices connected to it) operate much more efficiently: as soon as a particular source MAC address is *learned* (i.e., seen in a packet arriving on a particular interface on the switch), then the switch stores that MAC address and interface number in its FDB, so that any traffic destined for that MAC address can be sent to the correct interface, and no other interfaces.

In embodiment herein, the agent queries a switch for its FDB, either using an appropriate SNMP MIB (such as the Bridge MIB), or using a CLI command (such as “show fdb” on a Cisco switch or router). In the above example, if the agent can discover the new desktop computer by (say) scanning the subnet to which it belongs, then it might be able to determine the MAC address of the interface on the new desktop computer. Then, if it sees the MAC address in the FDB for a switch (which, in the example, contains a row involving port 17), the agent can infer that the computer is connected at layer 1 to switch port 17.

The FDB provides an example of how of the agent can make use of *indirect evidence*. LLDP and the like are *direct evidence* of a layer 1 connection, but with appropriate computations, layer 1 connections can be inferred from the FDB.

### The ARP Table

Just as the FDB associates layer 2 information with layer 1, the *address resolution protocol table* (ARP table) associates layer 3 information with layer 2 information.

In the earlier discussion of the routing table, which contains layer 3 information, the concept of a default route was discussed. When a device with a particular network address wishes to send traffic to a destination network address, and its routing table does not contain specific information about that destination address, then the device sends the traffic using the default route, which is itself a destination address. That destination address is assumed to be on the next hop (i.e., on another device) towards the final destination address.

Reconsider the new desktop computer example. An interface on a desktop computer is programmed with a layer 2 address (such as an Ethernet MAC address) at manufacturing time: it is something that does not change throughout the lifetime of the interface. However, when the computer is powered on and the interface plugged into a switch, a layer 3 address (such as an IP address) must be assigned to the interface.

It is possible to program the interface to use a particular IP address and netmask, every time it is powered on. This is called *static configuration*. It is also possible for the interface to request an address and netmask from a server, whose job is to assign it an available address from a particular subnet (for example, using the *dynamic host configuration protocol*, or DHCP). This is called *dynamic configuration*.

As part of layer 3 interface configuration, a default route must also be configured. This, too, can be statically configured, or dynamically configured.

Suppose that after power on, the end user of the desktop computer opens their email program to check for new email. The email program will be configured to know the IP address (the layer 3 address) of the company email server. But, the desktop computer cannot yet communicate with the email server: it does not know the MAC address (the layer 2 address) of the email server.

This is where ARP comes in. It is possible for the desktop computer to issue an *ARP request*, which is a packet that asks the question, “What is the MAC address associated with IP address A.B.C.D?”, where A.B.C.D is the IP address of the email server. That packet arrives at the switch; if the email server has been online for several hours, then it is likely one of the other desktop computers connected to the switch has also attempted to access the email server. In that case, there will be an entry in the ARP table on the switch containing both the IP address of the email server and its MAC address.

So, the switch can issue an *ARP reply* to the new desktop computer using the information from its ARP table, which says “IP address A.B.C.D has MAC address X”. That allows the desktop computer to put the correct destination MAC address (that of the email server) into any packets that it sends out its interface. Traffic can now flow between the desktop computer and the email server, and now the end user can receive email on their desktop computer.

The agent can use the ARP table as follows. Sometimes, the agent will be able to discover the existence of a device (for example, by sending it an ICMP ping packet), but it might not be able to query the device for information about the MAC address of its interface (because, for example, SNMP is not enabled on the device, and CLI credentials are not known or the like). So, the agent might know the layer 3 address of the device, but nothing more.

However, if the agent can query the switches and routers for their ARP tables, then it becomes possible to infer the MAC address for the device, given that its IP address is known. Thus, for example, if all that is known about a device is its IP address (say, 10.8.3.78), there could well be an entry in the ARP table on a switch or router which says, “IP address 10.8.3.78 has MAC address B8:E8:56:00:01:47.” Moreover, once the MAC address for a device is known, the FDB can be used to determine which port on a switch or router the device is connected to. For example, the FDB on a switch might say, “MAC address B8:E8:56:00:01:47 is associated with interface 17.”

Thus, an embodiment of the agent infers layer 1 connection information for a device about which only its layer 3 address is known, so long as the ARP table and the FDB from another device can be queried (using SNMP or a CLI). This is a second example of indirect evidence: using only the IP address for a device, the agent uses the ARP table from a router to get its MAC address, and the FDB from a switch or router to get its physical interface number. Thus, layer 3 information can give layer 2 information, which can give layer 1 information.

### Unmanaged Device Inference

Certain network devices are “invisible”: they do not respond to ping, and they have no open TCP or UDP ports. An example of a device like this, a hub, was mentioned earlier. This is a physical “one to many” switch. For example, suppose there is a single Ethernet port on a desktop computer, and it is required to attach multiple Ethernet devices to this port (say, a laser printer and a photo printer). A simple hub allows this: it has an *input interface* into which the computer's interface is plugged, and then it has (for example) four *output interfaces*, each of which can be plugged into a separate device. So, the laser printer interface can be plugged into one output interface, and the photo printer interface to another output interface.

Devices like hubs are termed *unmanaged*: they are passive devices, which have internal electronics that permit *multiplexing* (dividing traffic from the input interface into multiple output interfaces, and vice versa), but otherwise, they cannot be communicated with (i.e., directly managed by an end user).

In embodiments of the system and method, the agent can infer that an unmanaged device is present in a network.

In the earlier example, a new desktop computer was plugged into interface 17 of a switch. Suppose that all 24 interfaces on the switch are used (which is to say, every interface has an Ethernet cable plugged into it). And, further suppose that a new printer is purchased. How can the printer be added to the network, so that it can be used by everyone?

It is possible for the network manager to buy a second switch, and move the wires around to attach the second switch to the company network, and then wire the new printer into the second switch. However, a 24-interface switch is often substantially more expensive than a simple 4-interface hub. Instead of buying a whole new 24-interface switch, a network manager might buy a cheap 4-interface hub, and interpose this hub between the newest computer and the switch.

So, switch interface number 17 is detached from the new computer, and plugged into the input interface of the hub. Then, the new computer's interface is plugged into one of the hub's output ports, and the new printer is plugged into a second output port on the hub.

What will happen in the FDB of the switch? There will be traffic arriving from two different MAC addresses on switch interface 17: the MAC address of the new computer's interface, and the MAC address of the new printer's interface. This is legal; it simply means that there are two entries in the FDB for interface 17, one with the computer's MAC address, and one with the printer's MAC address

There can be only one physical Ethernet cable plugged into an interface. An embodiment of the agent program sees from the FDB that there are two MAC addresses associated with switch interface 17, which means there are two devices “plugged into” interface 17. Since this is impossible, the agent infers the presence of an unmanaged hub attached to switch interface 17. This is a third example of indirect evidence regarding layer 1 connections that can be determined by the agent.

### Layer 2 Topology Determination

The vast majority of target networks use Ethernet at layer 2. And, the large majority of those use dot 1Q VLAN tags to manage layer 2 connections.

As noted above, the agent can build layer 2 topology using SNMP or CLI to query devices regarding their layer 2 configuration. Examples of relevant configuration information include the following.
An interface is an *access interface* or *access port* if it is specifically configured to receive only dot 1Q untagged traffic. Any dot 1Q tagged packet which arrives at the interface is ignored.
An interface is a *trunk interface* or *trunk port* if it is specifically configured to receive dot 1Q tagged traffic. A trunk interface is configured with a *default tag*, and optionally one or more other tags. Suppose the default tag is 2, and the interface is also configured for tags 5 and 19. Then any arriving packet with no dot 1Q tag is modified to include dot 1Q tag 2 (the default tag) before being sent onward. And, any arriving packet with dot 1Q tag 2 (the default tag) is modified before being sent onward to remove the tag, meaning it is sent with no dot 1Q tag. Finally, any arriving packet with dot 1Q tag 5 or 19 is sent as-is, with no modification to the dot 1Q tag. All other arriving packets (i.e., dot 1Q tagged packets with any tag other than 2, 5, or 19) are ignored.

Thus, the agent is configured to collect access and trunk information about all interfaces, and also determine interfaces that are grouped as part of a port channel, and also reads MAC-based ACLs from any device which supports them. (The earlier discussion of ACLs talked about network layer, or layer 3, ACLs, but some switches support layer 2 ACLs as well.)

### Layer 3 Topology Determination

There are several sources of layer 3 information that are useful for building layer 3 topology: routing tables, default gateways, layer 3 ACLs, ARP tables (which associate layer 3 addresses with layer 2 addresses, and so imply that a device at a particular layer 3 address has been active recently). The agent uses SNMP or CLI to retrieve this information from as many devices as possible, in order to determine the layer 3 topology of the network.

### Network Visualizations

Once the devices and topology of a network have been discovered, it is desirable to present information about the network in a format that is convenient for an end user. For example, a network manager may wish to see a diagram or a “map” that represents the network in some way, or perhaps in different ways to answer different questions. There may be multiple “perspectives” in which such a map can present information to the user, each designed to convey different kinds of information.

As described, the device discovery and topology discovery procedures gather a quantity of information about the target network. Depending on which specific questions the network manager wishes to answer, not all of the available information may be relevant at all times. In order to avoid clutter and to ensure that the relevant information is presented clearly, it is desirable to filter the available information in some way.

### Physical Topology

One useful map perspective is a visual representation of the physical (layer 1) topology of the network, or in other words, a visual representation of the way in which the network devices are connected by physical wires (or wireless connections).

In one example, network devices are represented by circles, where properties of the circles represent properties of the corresponding network devices. For example, the colour of a circle may represent the class of the corresponding network device, a circle may contain an icon representing the class of the corresponding network device, or the size of a circle may represent the number of interfaces on the corresponding network device.

Further, physical connections between network devices are represented by lines between the circles representing the network devices, where properties of the lines represent properties of the corresponding connections and interface types. For example, the colour of a line may represent the type of connection (wired versus wireless), or a line may be solid or dashed to represent the type of connection. If there are multiple physical connections between the same pair of devices, the connections may be represented by multiple lines, or by a single line whose thickness represents the number of connections.

One or more interfaces on a network device may be represented by a corresponding number of smaller circles adjacent to the device circle. These interface circles may be rendered selectively based on whether there is an active physical connection using that interface; for example, a device with a large number of unused interfaces would not be cluttered by many adjacent small circles.

A label may be displayed next to each circle, containing a name or other identifier for the corresponding device.

Devices that require a network manager's attention, like misconfigured or offline devices, may be indicated with a different visual presentation. For example, the colour of the corresponding node may be changed, or a small “badge” may be overlaid on the corresponding node.

The collection of circles and lines (or more generally, to use the language of mathematical graph theory, “nodes” and “edges”) can be represented in a “force-directed graph layout”, where nodes repel one another, but are held together by edges or by a “gravitational force”. Such a graph tends to adjust its layout frequently as nodes and edges are added and removed, resulting in a very dynamic network representation.

In order to obtain a similar visual representation each time a map is rendered, each node may be initially positioned at a predictable position. The position may be determined based on the class of the corresponding network device, on a name or other identifier for the device, or on other criteria. For example, nodes representing firewalls, switches, and routers, may be initially positioned near the top of the map representation. It is worth noting that because of the inherent dynamic nature of a force-directed layout, the initial positions of the nodes may not always be maintained as the layout adjusts itself.

In some cases, certain nodes may be “fixed” in place so that their positions do not change as the layout adjusts itself. For example, a node representing the default gateway for the network (the node where the internal network is connected to the outside world) may be positioned at the top centre of the map, and fixed in place so that the rest of the nodes appear below it. Other nodes may also be fixed in specific positions based on the class of device they represent or on other criteria.

In some cases, a user may drag nodes around on the map to manually adjust their positions using a mouse gesture, for example. Once a node has been manually positioned, it may resume moving as part of the force-directed layout from the position in which it was dropped, or it may remain fixed in the position in which it was dropped. If it remains fixed, there may also be a way for the end user to indicate that it should once again resume moving as part of the force-directed layout.

In some cases, it may be desirable to have a more predictable and reproducible visual representation of the physical topology. In a different layout for the map, the collection of nodes and edges are represented in a more static “tree” structure. Generally, the “root” of the tree may be the node representing any device on the network, but in one case, the root of the tree can be the node representing the default gateway for the network. The devices connected to the root network device are then represented at the “second level” of the tree, the devices connected to the second level devices are then represented at the “third level” of the tree, and so on. The “children” of each node can be positioned left-to-right in a fixed, predictable order, based on the class of the corresponding device, on a name or other identifier for the device, or on other criteria.

In some embodiments, the device and topology discovery procedures may be capable of identifying the default gateway for the network, and the map is initially rendered with the corresponding node as the root of the tree structure. If the device and topology procedures are not capable of identifying the default gateway for the network, the network manager may manually choose a node to be designated as the default gateway. For example, the user interface may present a drop-down list of one or more devices in the network that are capable of acting as a default gateway, and the network manager may select a device from the list. Subsequently, the user interface may present a drop-down list of interfaces on the selected device, and the network manager may select an interface from the list. (Conceptually, the selected interface represents the interface by which the network is connected to the outside world, i.e., devices that are not part of the target network.)

In almost any type of layout, as the number of network devices and connections grows, it may be impractical to render every single visual element on the display at the same time. As such, it is desirable to form strategies to deal with displaying larger networks compactly, so that the volume of information does not overwhelm the end user.

For example, in one case the nodes and edges are all rendered, and the map begins “zoomed out” to a point where all of the visual elements are visible. This may provide a complete overview of the network topology, but in larger networks, individual nodes and edges may need to be rendered at a very small size in order to fit on the display. Thus, the map may provide zoom controls, in the form of buttons for the like, to modify the zoom level, or by responding to mouse events like scroll or double-click. The map may also provide pan controls, in the form of buttons or the like to modify the current position of the viewport, or by responding to mouse events like click or click-and-drag.

Providing the ability to zoom and pan the map allows the network manager to focus in on a specific part of the map that is of interest, and to zoom in to a level where the nodes and edges are large enough to be seen clearly.

In some cases, certain visual elements may not be visible at all zoom levels. For example, always displaying a label containing the name or other identifier for each device may result in a visually cluttered appearance when many devices are visible. To determine which labels should be displayed, each device may be given an “importance” score depending on a number of criteria, such as the class of the device, the distance from the root node of the map, the number of connections that the device has, the zoom level, and the overall density of the map. Numeric values for these criteria may be combined in a mathematical formula to obtain a single importance score for each device, and the labels for devices below a particular importance score threshold may be hidden entirely, or their opacity may be decreased so they are not as prominently visible.

At some zoom levels, certain nodes may be consolidated together into one node representing multiple devices. For example, several workstation devices that are all connected to the same switch may be represented as one node containing one or more workstation icons. In some cases, devices of different types may be represented by a single node, in which case the consolidated node may contain icons for each of the multiple types of devices. The decision as to whether to consolidate nodes may be based on the same importance function as described above. For example, if a node and all of its children have an importance below a particular threshold, then they could be consolidated into a single node. Similarly, if all of the children of a node have an importance below a particular threshold, then they could all be consolidated into a single node with multiple connections back to their parent.

Providing consolidation in a manner like this allows the network manager to see a “summarized” view of the high-level network elements, and to obtain more detail on particular areas of the map by zooming in to a level where the nodes in that area are no longer consolidated.

### Logical Topology

Another useful map perspective is a visual representation of the logical topology of the network, or in other words, a visual representation of the way in which the network devices are associated with VLANs (either dot 1Q VLANs or otherwise) or IP layer subnets.

In this case, each of the VLANs configured on the network may be represented by a circle. Each device with at least one interface capable of routing traffic on a VLAN is represented by a circle within the corresponding VLAN circle. Finally, each interface capable of routing traffic on a VLAN is represented by a circle within the corresponding device circle.

Further, each of the IP layer subnets configured on the network may be represented by a circle. Each device with at least one interface with an IP address on a subnet is represented by a circle within the corresponding subnet circle. Finally, each interface with an IP address on a subnet is represented by a circle within the corresponding device circle.

In some cases, the map may contains a circle representing “unused” interfaces, namely those that are not part of a VLAN or an IP layer subnet. Each device with at least one unused interface may be represented by a circle within the unused interface circle. Each unused interface is represented by a circle within the corresponding device circle.

Note that one or more of these cases may be visually presented at the same time, and as a result, a device may appear more than once in the logical topology map. (In fact, in some cases, a device may appear more than once even within the same type of display: a device that can route traffic on more than one VLAN would be rendered within multiple VLAN circles, for example.)

As noted above, a label may be displayed next to or inside each circle, containing a name or other identifier for the corresponding VLAN, IP layer subnet, device, or interface.

Also, the display may be configured such that not all of the circles are visible when the map is first rendered. For example, only the outer circles and the device circles may be visible at first, and the interface circles may be hidden. Similarly, labels for some of the circles may be hidden based on the zoom level or the size of the circle. The map may provide zoom controls, in the form of buttons to modify the zoom level, or by responding to mouse events like scroll or double-click. The map may provide pan controls, in the form of buttons to modify the current position of the viewport, or by responding to mouse events like click or click-and-drag. As the zoom level increases, the interface circles and text labels may become visible.

### Combining Perspectives

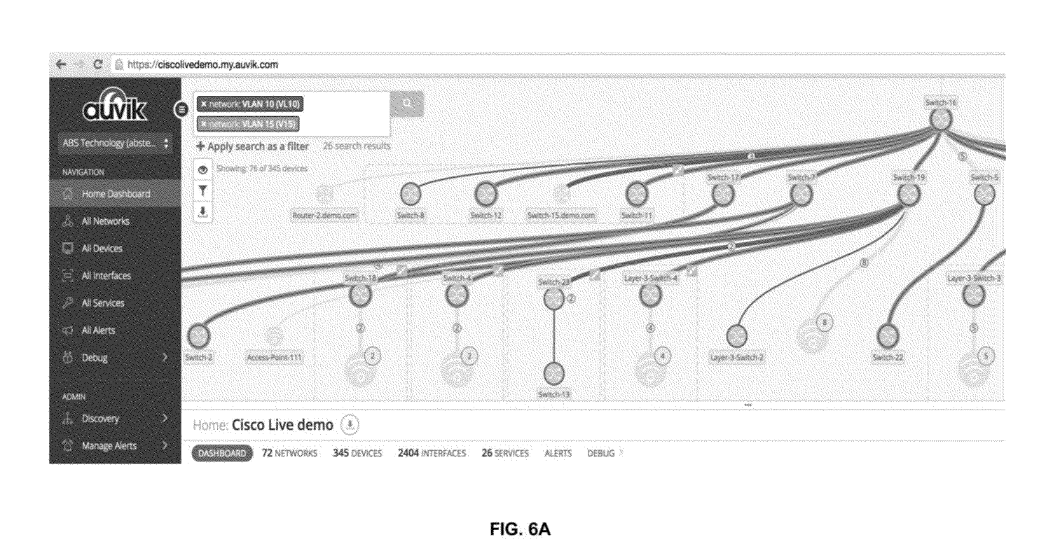

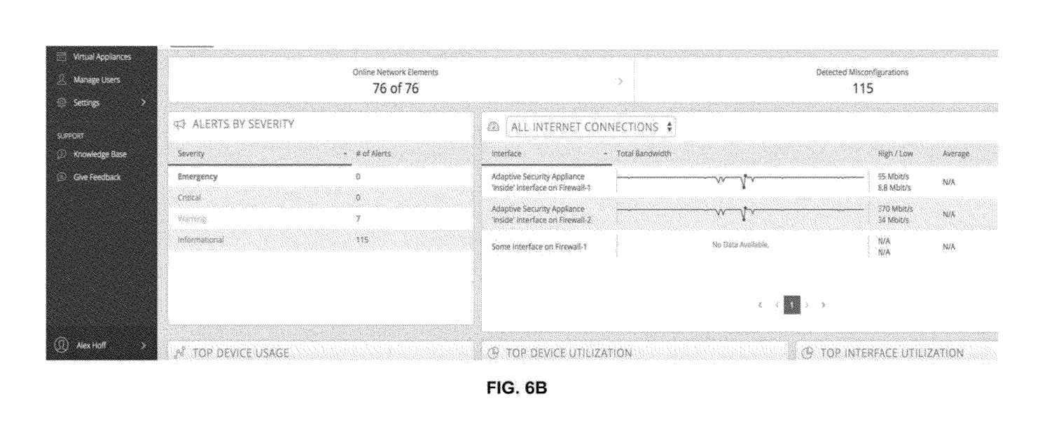

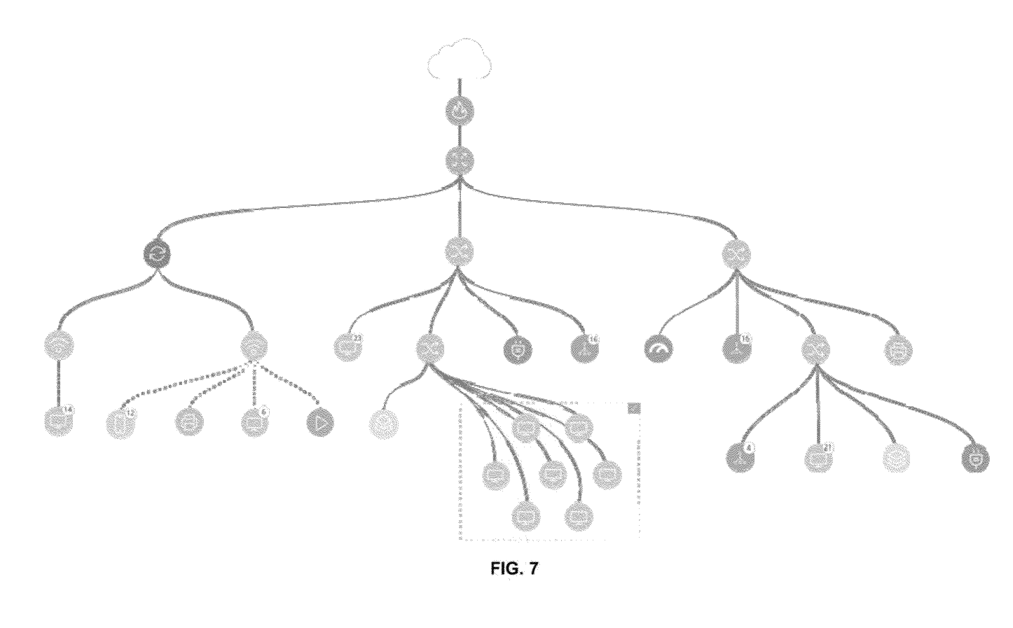

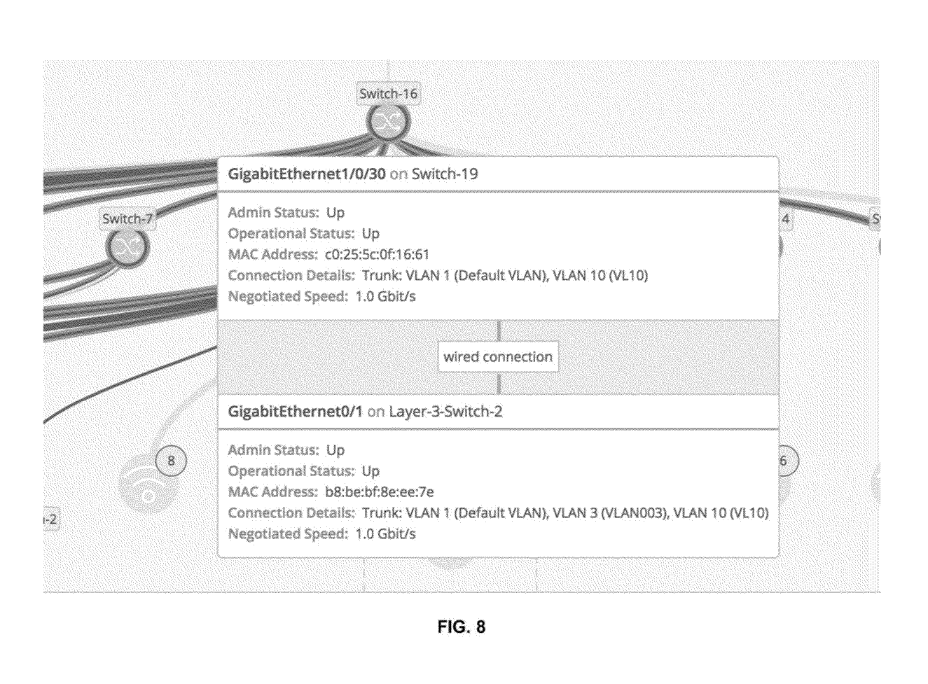

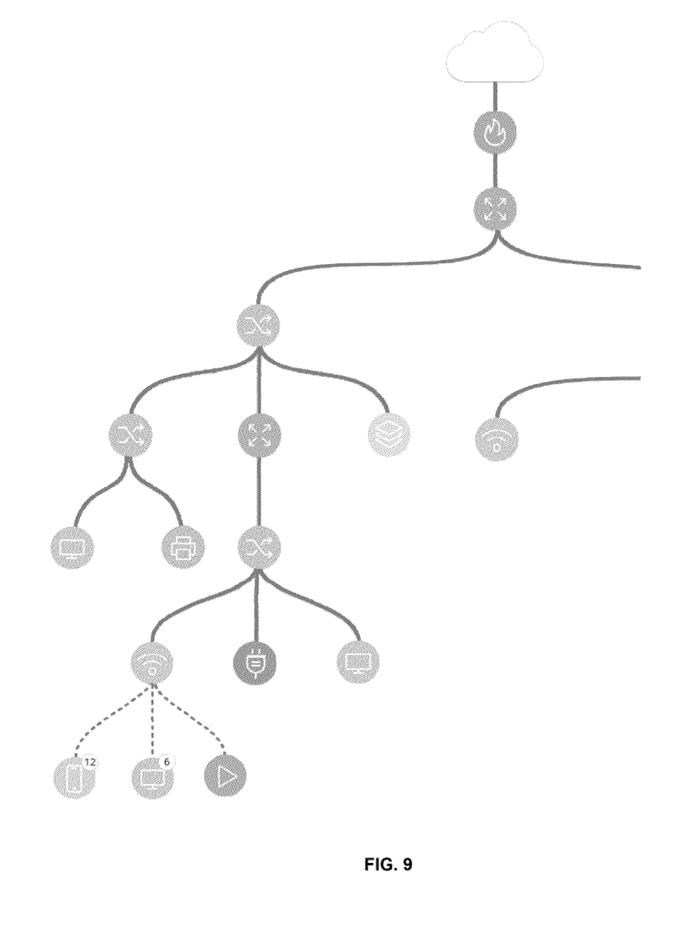

In some cases, one or more of the various maps may be rendered at the same time. For example, one half of the display could be used to render a physical topology map while the other half of the display could concurrently be used to render a logical topology map. Examples of various views provided by the system and method for network topology are shown in FIGS. 6A to 9.

In some cases, whenever the mouse cursor is placed over a circle, that circle may be “highlighted” with a different visual presentation, for example by brightening its colour, or by outlining it in a darker colour. If the corresponding network element is represented by one or more additional circles on the display, in the same or in a different perspective of the map, all of those additional circles may be highlighted in the same way.

In other cases, whenever the mouse cursor is placed over a circle, a “tooltip” (a box with textual information) may appear that contains additional information about the corresponding network element. The tooltip may appear near to the current cursor position, or it may appear in a dedicated area of the map.

It may also be desirable to present physical and logical topology information in a single perspective, to allow the network manager to focus on a single source of data and to simplify the visual appearance of the page.

In this case, the physical topology map may be presented on the display according to one or more of the options described herein. In a dedicated section of the display beside the map, for example, there may be a user interface control that generally allows the user to select layers to be overlaid on the map. Examples of such layers are VLANs, IP layer subnets, devices with unused interfaces, or devices that have been “tagged” by the user with a particular keyword. The items related to a VLAN layer would be the devices, interfaces, and connections that are capable of routing traffic on that VLAN; the items related to an IP layer subnet would be the interfaces with IP addresses in the corresponding address space, along with the devices corresponding to those interfaces and any connections between them; and so on. When a particular layer is selected, the items related to that layer are given a different visual presentation. For example, items may be highlighted with a broad stripe of semi-transparent colour to indicate their membership in the layer, or the items that are not related to a selected layer may be “faded out”.

In some cases, the network manager may select multiple layers to be displayed concurrently. In that case, each selected layer may be distinguished from the others with a different colour, or the union of the items related to all of the selected layers may be given the same visual treatment.

In some cases, a network manager may wish to visualize a path from one device on the network to another. For example, the user interface may provide a method to select a pair of devices on the network. When two devices are selected, the map zooms out to a point where both devices are visible, and the path from one device to another is highlighted on the map using a different visual presentation. For example, the edges along the path may be drawn in a different colour or width. Note that there are multiple ways that devices might be “connected”: layer 1, layer 2, or layer 3. Thus, the edges between the connected nodes might differ, depending on the current properties of the visualization.

In some cases, a network manager may wish to visualize properties of the network such as network congestion. In some cases, the edges of the map may be rendered using a different visual presentation based on the property being visualized. For example, if the network manager chooses to visualize network congestion, some edges may be coloured green, yellow, or red to indicate whether the corresponding connections in the network are not congested, somewhat congested, or very congested, respectively.

### Statistics and Historical Information

In addition to the map visualizations, it is also desirable to present information related to the network in other formats.

For example, there may be a network summary page that presents key statistics about the network, such as the number of devices on the network, the number of devices that require attention, any important events related to network discovery or performance, graphs of network availability indicators, and charts of the most active network devices, among others.

In some cases, the user can click on (or otherwise select) a particular VLAN, IP layer subnet, device, or interface, and the display will be updated to present information about the selected network element. For example, the selected network element will be highlighted with a different visual presentation on the map visualization, and the statistical information will be updated to reflect the selected network element.

According to an aspect herein, there is provided a system and method for discovering devices connected within a network. Such a system and methods includes: a software program (the *agent*) which executes on a device (the *initial device*) inside the network whose devices are to be discovered (the *target network*), which includes:
an *interface detection module*, which
detects network interfaces on a device;
determines the network addresses assigned to said interfaces;
determines address ranges associated with said network addresses;
a *scanning module*, which
discovers additional devices by probing the network addresses from said address ranges;
an *inventory module*, which
directs said interface detection module to execute on the initial device;
stores network address ranges, as found by said interface detection module;
directs said scanning module to scan network addresses that have not yet been scanned;
stores all network addresses at which network devices are discovered;
directs said interface detection module to execute on said discovered additional devices.

Embodiments of the system and method for topology discovery may also include a visualization module, which displays the network information detected in an interactive visual display or map of the network topology at various levels with option statistical information also displayed.

In the preceding description, for purposes of explanation, numerous details are set forth in order to provide a thorough understanding of the embodiments. However, it will be apparent to one skilled in the art that these specific details may not be required. In other instances, well-known structures and are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the disclosure should not be limited by the particular embodiments set forth herein, but should be construed in a manner consistent with the specification as a whole.

We claim:

1. A method for managing data integrity comprising:
receiving, at a transmitter module, a plurality of constraints related to a data structure stored in a data storage component;
analyzing, at a constraint translator module, each of the plurality of constraints to determine a plurality of conditions based on the plurality of constraints;
determining, at an analysis component, a plurality of operations based on each of the plurality of conditions, wherein each operation provides for changes in data associated with a portion of the data structure; and
generating, at the constraint translator module, computer executable code based on the at least one constraint, the conditions and the operations.

2. The method of claim 1 wherein the data structure is a plurality of tables and a portion of the data structure is a table within the plurality of tables.

3. The method of claim 1, further comprising executing, at a processor, the generated code to determine changes required to data previously stored in the data structure.

4. The method of claim 1, further comprising notifying a constraint author of a condition that cannot be resolved.

5. The method of claim 1, wherein determining the plurality of operations comprises determining downstream operations based on the determined operations, wherein the downstream operations provide for changes in data associated with other portions of the data structure.

6. The method of claim 1, wherein determining operations is based on predetermined preferences.

7. The method of claim 1, wherein analyzing each of the plurality of constraints comprises determining corner cases related to the constraint.

8. The method of claim 1, further comprising:
monitoring, at a monitoring component, for a change made to a portion of the data structure;
determining, at a constraint executor module, whether the change violates a constraint of the plurality of constraints; and
if the change violates the constraint, returning each portion of the data structure to a valid state, otherwise proceeding with the change, at a modification component.

9. The method of claim 8, wherein returning each portion of the data structure to a valid state comprises executing, at a processor, the generated code to determine changes required to data previously stored in the data structure.

10. The method of claim 8 wherein returning each portion of the data structure to a valid state comprises:
determining downstream operations based on the change to the portion of the data structure, wherein the downstream operations provide for changes in data associated with other portions of the data structure.

11. A system for managing data integrity comprising:
a transmitter module configured to receive a plurality of constraints related to a data structure stored in a data storage component;
a constraint translator module configured to analyze each of the plurality of constraints to determine a plurality of conditions based on the plurality of constraints;
an analysis component configured to determine a plurality of operations based on each of the plurality of conditions, wherein each operation provides for changes in data associated with a portion of the data structure; and
wherein the constraint translator module is further configured to generate computer executable code based on the at least one constraint, the conditions and the operations.

12. The system of claim 11, wherein the data structure is a plurality of tables and a portion of the data structure is a table within the plurality of tables.

13. The system of claim 11, further comprising a processor configured to execute the generated code to determine changes required to data previously stored in the data structure.

14. The system of claim 11, further comprising a transmitter module configured to notify a constraint author of a condition that cannot be resolved.

15. The system of claim 11, wherein the analysis component is configured to determine downstream operations based on the determined operations, wherein the downstream operation provide for changes in data associated with other portions of the data structure.

16. The system of claim 11, wherein determining operations is based on predetermined preferences.

17. The system of claim 11, wherein the analysis component is configured to determine corner cases based on the plurality of constraints.

18. The system of claim 11, further comprising:
a monitoring component configured to monitor for a change made to a portion of the data structure;
a constraint executor module configured to determine whether the change violates a constraint of the plurality of constraints; and
a modification component configured to, if the change violates the constraint, return each portion of the data structure to a valid state, otherwise proceeding with the change.

19. The system of claim 18, further comprising a processor configured to return each portion of the data structure to a valid state by executing the generated code to determine changes required to data previously stored in the data structure.

20. A method for managing data integrity comprising:
monitoring for a change made to a portion of a data structure stored in a data storage component;
analyzing updates to each portion of the data structure based on the change; and
determining whether the change violates at least one predetermined constraint associated with a portion of the table structure, wherein if the change violates at least one predetermined constraint, returning the data structure to a valid state by performing data changes to other portions of the data structure, otherwise proceeding with the change.
